(19) United States
(12) Patent Application Publication
(10) Pub. No.: US 2025/0043579 A1
(43) Pub. Date: Feb. 6, 2025

(54) SHUTTERING ELEMENT

(71) Applicant: PERI SE, Weissenhorn (DE)

(72) Inventors: Gunther Staudenrausch, Weissenhorn (DE); Andreas Spiegl, Weissenhorn (DE); Philipp Rusch, Weissenhorn (DE); Martin Stoerk, Weissenhorn (DE)

(73) Assignee: PERI SE, Weissenhorn (DE)

(21) Appl. No.: 18/713,293

(22) PCT Filed: Nov. 17, 2022
(86) PCT No.: PCT/EP2022/082248

§ 371 Date: May 24, 2024

(30) Foreign Application Priority Data
Nov. 26, 2021 (DE) 10 2021 131 124.1

(51) Int. Cl. E04G 17/00

(52) U.S. Cl. CPC E04G 17/00

(57) ABSTRACT

A shuttering element for shuttering a building part comprising a shuttering frame and at least one shuttering shell which is connected to the shuttering frame and which, in use, rests with a shaped surface against a building part to be erected, wherein an edge extends around the shaped surface. The shuttering element further comprises at least one sealing profile which is located between the shuttering shell and the shuttering frame, wherein the shuttering frame has a contact surface on which, in use, the shuttering shell rests in regions, and the shuttering frame also has a frame edge which is located next to the contact surface and extends around said contact surface at least in regions, wherein the frame edge protrudes beyond the contact surface in a direction perpendicular to the contact surface.

### FIELD

The invention relates to a shuttering element for shuttering of a building part comprising a shuttering frame and at least one shuttering shell which is connected to the shuttering frame and which, in use, rests with a shaped surface against a building part to be erected, wherein an edge extends around the shaped surface. The shuttering element further comprises at least one sealing profile which is located between the shuttering shell and the shuttering frame, wherein the shuttering frame has a contact surface on which, in use, the shuttering shell rests in regions, and the shuttering frame also has a frame edge which is located next to the contact surface and extends around said contact surface at least in regions, wherein the frame edge protrudes beyond the contact surface in a direction perpendicular to the contact surface, and wherein the sealing profile is located, at least in regions, between the frame edge and the edge of the shuttering shell extending around the shaped surface. The invention further relates to a method for assembling a shuttering element.

### BACKGROUND

For producing building parts such as walls or ceilings, shuttering is used. Such shuttering is designed so that, in its interior, the negative form of a building part to be erected is produced. Then, a concrete material which will form the building part after it has hardened is filled into the shuttering. In the last step, the shuttering is removed from the building part and can preferably be used for producing other building parts. A shuttering is usually assembled from a plurality of shuttering elements. Such a shuttering element usually comprises a frame which absorbs the forces acting on the shuttering elements from the poured-in concrete material. The actual boundary surface of the shuttering element to the concrete material is formed a shuttering shell which is mounted in the shuttering frame. Since the concrete material is initially liquid when it is filled into the shuttering a sealing between the shuttering frame of a shuttering element and the mounted shuttering shell is required. This sealing usually takes place by means of a liquid sealing material, for example, silicone which is injected into a gap between the edge of the shuttering shell and the shuttering frame. This injection is performed manually during the installation of the shuttering shell in the shuttering frame. After the injection of the sealing material, the excessive sealing material protruding beyond the sealing area has to be removed to ensure a smooth surface of the shuttering element. Then, the liquid sealing material will take time until it has hardened and forms a stable seal between the shuttering frame and the shuttering shell. A drawback of this procedure is that a large part of the injected sealing material leaks from the sealing area and has to be removed. In this way, more sealing material than required for the actual sealing is required. In addition, this sealing is time-consuming and, in addition, renders it necessary that, after the sealing, the shuttering element cannot be used for a certain amount of time, namely, until the sealing has hardened. Moreover, it may occur that the quality of a sealing produced in this way is uneven since a manually performed process usually does not yield reproducible results. If the sealing is of a poor quality in specific areas, it may occur that, in use of the shuttering, concrete material seeps in between the shuttering shell and the shuttering frame in some places. These places can be seen on the produced building part after the removal of the shuttering element and have to be removed with expenditure of time being involved. Finally, the used sealing materials, particularly silicone or Pactan, are harmful to the environment and produce unpleasant and potentially health-threatening odours in processing.

### BRIEF SUMMARY

The object of the invention is therefore the proposal of solutions by means of which the sealing of the shuttering frame of a shuttering element with respect to a shuttering shell installed in the shuttering frame can be improved.

The object of the invention is solved by a shuttering element for shuttering a building part comprising:
a shuttering frame which supports the other elements of the shuttering element and absorbs loads acting on the shuttering element in use,
at least one shuttering shell which is connected to the shuttering frame and which, in use, rests with a shaped surface against a building part to be erected, an edge extending around the shaped surface,
at least one sealing profile which is located between the shuttering shell and the shuttering frame and particularly connects the edge of the shuttering shell extending around the shaped surface to the shuttering frame in a sealing manner, the sealing profile extending along a direction of extension comprising the following elements:
at least one sealing body which, at least in portions, is made of an elastic material, the sealing body having at least two abutment surfaces which, at least in sections, abut on the shuttering frame and/or the shuttering shell, the abutment surfaces being disposed on opposite sides of the sealing body and respectively extending parallel to the direction of extension, and each of the abutment surfaces being larger than the end faces of the sealing body disposed between the abutment surfaces, the sealing body having at least two sealing surfaces respectively one of which forms a portion of an abutment surface,
at least one mounting element which is connected to the shuttering frame or the shuttering shell, the mounting element being connected to the sealing body and particularly disposed on one of the abutment surfaces,

the shuttering frame having a contact surface on which, in use, the shuttering shell rests in regions, and the shuttering frame also having a frame edge which is located next to the contact surface and extends around said contact surface at least in regions, the frame edge protruding beyond the contact surface in a direction perpendicular to the contact surface, and the sealing profile being located, at least in regions, between the frame edge and the edge of the shuttering shell extending around the shaped surface, and a surface of the frame edge oriented in the direction of the shuttering shell being arranged at an angle other than 90° with respect to the contact surface, and/or the edge being arranged at an angle other than 90° with respect to the contact surface.

A shuttering element according to the invention is provided to form a portion of a shuttering for producing a building part. The shuttering element according to the invention comprises a shuttering frame, a shuttering shell, and an interposed sealing profile sealing the shuttering frame with respect to the shuttering shell. In contrast to prior art, the sealing profile is already in the solid state, i.e. not in the liquid state during the assembly of the shuttering element. The effect of the shuttering element according to the invention arises from the shape of the sealing profile in combination with the adjacent elements of the shuttering frame and the shuttering shell.

The shuttering frame constitutes the supporting component part of the shuttering element and supports other elements of the shuttering element such as, for example, the shuttering shell. In use, i.e. in a case in which the shuttering element is used in a shuttering for producing a building part, the shuttering frame absorbs the loads acting on the shuttering element. Such loads may be caused, for example, by the pressure of a concrete material filled into the shuttering. The shuttering element further comprises a shuttering shell forming the largest part of the surface area of the shuttering element abutting on a building part to be erected. The shuttering shell has a shaped surface facing the concrete material. In most cases, the shaped surface has a planar design. However, it is also conceivable that the shaped surface has a curvature around one or a plurality of axes of curvature. Around the shaped surface, an edge extends which is preferably arranged at an angle of 30° to 150° with respect to shaped surface. The shuttering element according to the invention further comprises a sealing profile which is positioned between the shuttering shell and the shuttering frame in a sealing manner. A sealing profile is to be understood to be a sealing which extends along a direction of extension in a defined cross section. The sealing profile has its longest dimension along the direction of extension. The cross section of the sealing profile may be constant along the direction of extension or also vary along the direction of extension. Preferably, the shape and size of the cross section of the sealing profile is at least regular along the direction of extension. The sealing profile may be made available, for example, on a reel or spool, the sealing profile being wound around the reel or spool in the direction of extension in this case. In the mentioned example, the sealing profile can be cut and mounted according to the required lengths during the assembly of the shuttering element. The sealing profile comprises a plurality of elements: the sealing profile comprises a sealing body which is, at least partly, made of an elastic material. It is also possible that the entire sealing body is made of an elastic material. The elastic material elastically deforms during the assembly of the shuttering element and thereby reliably fills the clearance between the shuttering shell and the shuttering frame. The sealing body may also comprise elements made of a non-elastic material, for example, elements stabilising the shape of the sealing body such as, for example, embedded metal wires. In addition, other elements may be arranged in the sealing body, for example, sensors. The sealing body comprises at least two abutment surfaces respectively one of which abuts on the shuttering frame, and another one on the shuttering shell. The two abutment surfaces are disposed on opposite sides of the sealing body and connected to each other by two end faces, the end faces in turn being disposed on opposite sides of the sealing body. The two abutment surfaces and the two end faces extend along or parallel to the direction of extension of the sealing profile. The two abutment surfaces are larger than the two end faces of the sealing body. In addition, portions of the two abutment surfaces respectively form a sealing surface which abuts on either the shuttering frame or the shuttering shell in a sealing manner. In the mounted state of the sealing profile, it is not required that the entire abutment surfaces abut on the shuttering frame or the shuttering shell. It is also possible that portions of the abutment surfaces other than the sealing surfaces are disposed at a distance to the shuttering frame or to the shuttering shell. The sealing profile further comprises a mounting element which is connected to either the shuttering frame or the shuttering shell. Furthermore, the mounting element is fixedly connected to the sealing body. Preferably, the mounting element is disposed on one of the two abutment surfaces. The mounting element may have various designs, for example, as an adhesive surface or a protrusion on the sealing body provided for a positive or non-positive connection to the shuttering frame or the shuttering shell. In addition, the mounting element may also be implemented as a recess or cavity in the sealing body into which a protrusion of the shuttering frame or the shuttering shell is introduced for attachment. Furthermore, the mounting element may be formed by a mounting member which may be, for example, a pin or a screw. In this case, the mounting element, at least in sections, may be positively connected to the sealing body.

The shuttering frame has a contact surface the shuttering shell abuts on in the mounted state of the shuttering element. Preferably, the contact surface is considerably smaller than the shaped surface or a surface of the shuttering shell disposed opposite of the shaped surface. Preferably, the contact surface has a planar design. Furthermore, the shuttering frame has a frame edge disposed adjacent to the contact surface which protrudes beyond the contact surface in a direction perpendicular to the contact surface. In a plan view of the shuttering frame, the frame edge is preferably disposed on its outer edge. In this view, the contact surface is disposed within the frame edge. During assembly, the shuttering shell, in portions, is placed on the contact surface and, at least in portions, surrounded by the frame edge is in this state. Preferably, a surface on the frame edge arranged parallel to the contact surface is flush with the shaped surface of the shuttering shell in the mounted state. For sealing the shuttering shell and the frame edge, the sealing profile is arranged between a surface of the frame edge oriented in the direction of the shuttering shell and the edge of the shuttering shell. The surface of the frame edge facing the shuttering shell may be inclined with respect to the contact surface of the shuttering frame, i.e., arranged at an angle other than 90° and 0°. Alternatively or in addition, the circumferential edge of the shuttering shell may be inclined, i.e., oriented at an angle other than 90° and 0° with respect to the contact surface. Depending on whether the edge of the shuttering shell and/or the surface of the frame edge facing the shuttering shell are implemented so that they are inclined the sealing profile, as viewed in a cross section perpendicular to the direction of extension, may have a varying thickness in a direction perpendicular to the contact surface. The purpose of such an inclined arrangement of surfaces on the shuttering frame, the shuttering shell, or the abutment surfaces of the sealing profile is to provide for a centration for the installation of the shuttering shell in the shuttering frame. Such a centration helps to adjust the correct relative position of the shuttering shell with respect to the shuttering frame in a plan view of the shaped surface during the installation in which the shuttering shell is introduced into the shuttering frame in a direction perpendicular to the contact surface. For example, the surface facing the shuttering shell may be oriented at right angles to the contact surface. In this case, a centration can be achieved by the sealing profile being thicker on its side oriented in the direction of the contact surface than on its side oriented in the direction of the shaped surface. Such a sealing profile may have a, for example, wedge-shaped cross section. Complementary in shape, the circumferential edge of the shuttering shell may have an associated inclined orientation in this example. The angles of inclination of the wedge-shaped sealing profile and of the inclined edge of the shuttering shell are implemented so that they are identical in this example and are, for example, 15°. During the installation of the shuttering shell in the shuttering frame, the inclined edge of the shuttering shell slides along the wedge-shaped sealing so that the shuttering shell is centred inside the frame edge. During the assembly, the sealing profile is preferably elastically deformed so that, at least in portions, a reliable sealing is established between the frame edge and the edge of the shuttering shell. A centration may also be achieved in the reverse, for example, by the surface of the frame edge facing the shuttering shell being implemented so that it is inclined, and a wedge-shaped sealing profile being disposed on the edge of the shuttering shell. All possible combinations ensuring the described centration of the shuttering shell with respect to the shuttering frame during the assembly are included in the invention. In the embodiments described later, details relating to these possible combinations will be illustrated.

With a shuttering element according to the invention, the sealing between the shuttering frame and the shuttering shell is significantly improved. The sealing profile inserted between the frame edge and the edge of the shuttering shell is dimensionally adapted to the other components and is available in the already fully formed state during the assembly. The sealing profile is first connected to either the frame edge or the edge of the shuttering shell. In the next step, the shuttering shell is introduced into the shuttering frame with the aid of the centration provided for by the design of the frame edge, the sealing profile, and the edge of the shuttering shell. Said assembly can be quickly performed since no manual dimensional alignment and centration of the shuttering shell with respect to the shuttering frame is required like in prior art. In addition, after the placement of the shuttering shell on the contact surface in the shuttering frame, the sealing profile is already correctly positioned between the two elements and immediately functional. The manually performed process of providing for a sealing between the shuttering shell and the shuttering frame by introducing a liquid sealing material is therefore completely omitted. In this way, large amounts of sealing material are saved which, according to prior art, have to be removed after the introduction of the sealing material. In addition, the sealing between the shuttering frame and the shuttering shell is of a high quality since the shuttering frame, the sealing profile, and the shuttering shell were adapted to each other as early as during production. The assembly time for a shuttering element according to the invention is therefore significantly reduced as comparted to prior art, and, at the same time, the sealing between the shuttering shell and the shuttering frame is of a considerably better quality. Furthermore, it is advantageous that the sealing profile can be used repeatedly, for example, when the shaped surface of the shuttering shell has to be replaced due to wear. In addition, the sealing between the shuttering shell and the shuttering frame by means of the interposed sealing profile in a shuttering element according to the invention allows for a tolerance compensation of manufacturing tolerances. The shuttering frame and the shuttering shell may have lateral lengths of a plurality of metres which, of course, makes them subject to tolerances in their production. Dimensional inaccuracies in the range of several millimetres can be compensated without any problems by the sealing profile in a shuttering element according to the invention. In addition, thermally induced dimensional changes which may occur, for example, when the shuttering shell or the shuttering frame warm up can be compensated by the inserted, elastically preloaded sealing element. The shuttering element according to the invention therefore provides for an improved long-term impermeability between the shuttering frame and the shuttering shell both during assembly and in the mounted state in the use of the shuttering element. In addition, additional functions may be integrated in the sealing profile, for example by means of sensors measuring the temperature, the pressure, or the like.

In one embodiment, it is contemplated that the thickness of the sealing profile, particularly the distance between the abutment surfaces in a direction perpendicular to the direction of extension and parallel to the contact surface, varies in size starting from a plane defined by the shaped surface in the direction of a plane defined by the contact surface. In this embodiment, the thickness of the sealing body varies between its abutment surfaces in a direction perpendicular to the contact surface of the shuttering frame or to the shaped surface of the shuttering shell. Such a varying thickness can be used to provide for a centration during the installation of the shuttering shell in the shuttering frame. Furthermore, such a varying thickness can be used for positively fixing the sealing profile or the sealing body between the shuttering frame and the shuttering shell. Generally, the thickness of the sealing body may be larger or smaller in the plane defined by the shaped surface than in a plane defined by the contact surface here. The thickness of the sealing body may also vary between the planes defined by the contact surface and the shaped surface.

Skillfully, it is contemplated that the thickness of the sealing body, particularly the distance between the abutment surfaces in a direction perpendicular to the direction of extension and parallel to the contact surface, is larger or smaller in a plane defined by the shaped surface than in a plane defined by the contact surface. In this embodiment as well, the thickness of the sealing body varies. Here, the thickness of the sealing body on the side of the shaped surface of the shuttering shell may, in use, be larger or smaller than the thickness, in use, on the side of the contact surface. Here, the thickness may vary continuously or steadily. Alternatively, the thickness may change abruptly, for example due to a protruding section of the sealing body which protrudes beyond another section with a sharp-edged transition. Such a varying thickness can be used to accomplish a centration of the shuttering shell with the aid of the sealing profile during the installation in the shuttering frame or to positively secure the sealing profile between the shuttering frame and the shuttering shell against an unintended detachment in use.

In one embodiment, it is contemplated that, in a cross-sectional view perpendicular to the direction of extension, the sealing body, at least in portions, has a wedge-shaped design, at least one guide portion of the first abutment surface being disposed at an angle to at least one guide portion of the second abutment surface, the guide portion forming a portion of the first abutment surface, and the guide portion forming a portion the second abutment surface. In this embodiment, the thickness of the sealing body varies by a portion of the abutment surfaces being oriented at an angle with respect to each other. This portion of the abutment surfaces is respectively formed by a guide portion which preferably has a planar design, respectively. In a simple embodiment, a guide portion is provided on each abutment surface, and the two guide portions are oriented in a single angle with respect to each other. Alternatively, likewise, a plurality of guide portions oriented at different angles with respect to each other may be disposed on each abutment surface. In this way, a portion of the sealing body may be implemented so that it is repeatedly wedge-shaped. This embodiment is particularly favourable for serving as a centration or insertion aid during the installation of the shuttering shell in the shuttering frame. Here, the thicker side of the wedge-shaped portion of the sealing body may be oriented in the direction of the shaped surface or in the direction of the contact surface in use. Preferably, the angle between the guide portions is selected so that it interacts with either an angle formed between the surface of the frame edge facing the shuttering shell and the contact surface or an angle formed between the edge of the shuttering shell and the contact surface.

Advantageously, it is contemplated that the angle between a first guide portion of the first abutment surface and a second guide portion of the second abutment surface is 5° to 20°. Such an angle in this range is particularly favourable for accomplishing a centration of the shuttering shell during the installation in the shuttering frame or for positively fixing the sealing body between the shuttering shell and the shuttering frame in use.

Moreover, it is contemplated that the first sealing surface adjoins the first guide portion and/or the second sealing surface adjoins the second guide portion. Each abutment surface comprises a sealing surface and a guide portion. In this embodiment, the sealing surface and the guide portion are disposed directly adjacent to each other. In case of an arrangement of the guide portions at an angle relative to each other, the sealing surfaces may also be disposed at an angle relative to each other, or, on the other hand, be oriented parallel to each other. Alternatively, it is possible to arrange one or a plurality of transition areas between the sealing surface and the guide portion.

In one embodiment, it is contemplated that the first sealing surface is arranged so that it is flush with the first guide portion, and that the second sealing surface is disposed at an angle with respect to the second guide portion. Preferably, the first and the second sealing surface are oriented parallel to each other in this embodiment. The first sealing surface and the first guide portion are flush with each other and disposed in a common plane. The second guide portion is disposed at an angle with respect to the first guide portion and to the second sealing surface.

In an alternative embodiment, it is contemplated that the second sealing surface is arranged so that it is flush with the second guide portion, and that the first sealing surface is disposed at an angle with respect to the first guide portion. In this embodiment as well, the first sealing surface and the second sealing surface are preferably arranged parallel to each other. The guide portions are arranged at an angle with respect to each other, the first guide portion also being arranged at an angle with respect to the first sealing surface in this embodiment.

Moreover, it is contemplated that the first abutment surface adjoins the first end face, the first end face, on its side facing away from the first abutment surface, adjoins the second abutment surface, the second abutment surface, on its side facing away from the first end face, adjoins the second end face, and the second end face, on its side facing away from the second abutment surface, adjoins the side of the first abutment surface facing away from the first end face. In this embodiment, the sealing body is delimited by altogether four surfaces respectively adjoining each other in circumferential direction around the direction of extension. Of course, it is also possible to arrange additional surfaces on the sealing body in the circumferential direction around the direction of extension, for example, between the first end face and the first abutment surface.

Preferably it is contemplated that the first sealing surface is arranged parallel to the second sealing surface. This embodiment is particularly favourable in the interaction with an inclined edge of the shuttering shell or an inclined surface of the frame edge facing the shuttering shell. The two sealing surfaces arranged parallel to each other provide for a sealing portion of the sealing body which has a constant thickness. Particularly in a case in which the edge of the shuttering shell is implemented so that it is inclined so that it is closer the frame edge in a plane defined by the shaped surface than in a plane formed by the contact surface, one portion of the sealing portion is compressed more than another portion in the mounted state. The major sealing effect is obtained in this portion of higher compression. In the remaining portions between the sealing surfaces, the sealing body is compressed to a lesser extent which facilitates the installation of the shuttering shell in the shuttering frame. Due to the local high compression of the sealing body between the shuttering shell and the shuttering frame, however, a secure sealing between the two components is still ensured. Alternatively, it is also possible to arrange the first sealing surface at an angle other than 0° and 90° with respect to the second sealing surface.

In another embodiment, it is contemplated that the first end face is oriented substantially perpendicular to the first sealing surface and/or to the second sealing surface. In this embodiment, the first end face which usually contacts the concrete material in use is oriented at right angles to one of the two sealing surfaces. This is particularly favourable when this sealing surface abuts on a surface of the shuttering shell or the shuttering frame oriented perpendicular to the shaped surface.

Moreover, it is contemplated that the second end face is oriented substantially perpendicular to the first sealing surface and/or the second sealing surface. The second end face which is oriented towards the contact surface or the shuttering frame in use may also be oriented at right angles to one of the two sealing surfaces.

In an alternative embodiment, it is contemplated that the second end face is arranged at an angle of 45° to 89° with respect to the first abutment surface and/or the second abutment surface. In this alternative embodiment, the second end face is not arranged parallel to and not at right angles to at least one of the abutment surfaces. Such an embodiment is advantageous when, between the contact surface and the surface of the frame edge oriented towards the shuttering shell, the shuttering frame has a portion which is implemented correspondingly so that it is complementary in shape and which the second end face abuts on in use.

Skillfully, it is contemplated that the first end face and/or the second end face have a planar design. In case of a planar design of the first end face which contacts the concrete material in use, the transition area between shuttering frame and shaped surface of the shuttering shell is hardly visible so that the erected building part has an optically top-quality surface after the use of the shuttering element for its production.

Moreover, it is contemplated that, in a direction perpendicular to the direction of extension, the width of the abutment surfaces is at least twice as large as the width of the end faces in a direction perpendicular to the direction of extension. In this embodiment, the width of the abutment surfaces is significantly larger than the width of the end faces. In this way, the sealing body of the sealing profile obtains a slim design which is particularly suitable for the introduction between the shuttering frame and the shuttering shell. Preferably, the width of the abutment surfaces is about as large as the thickness the shuttering shell.

In one embodiment, it is contemplated that the first abutment surface extends in a plane, and that the first end face is oriented substantially perpendicular to the first abutment surface, the second end face being oriented at an angle of 45° to 89° with respect to the first abutment surface, and the width of the second end face in a direction perpendicular to the direction of extension being larger than the width of the first end face in a direction perpendicular to the direction of extension. In this embodiment, the width of the second end face is larger than the width of the first end face. A portion, particularly a guide portion of the first abutment surface is arranged at an angle with respect to a portion, particularly a guide portion of the second abutment surface. In addition, the second end face is oriented at an angle other than 0° and 90° with respect to the first abutment surface. The first end face is therefore not arranged parallel to the second end face. This embodiment is particularly suitable in a case in which an associated transition area designed so that it is complementary in shape is provided between the contact surface and the surface of the frame edge of the shuttering frame facing the shuttering shell. In this case, a positive connection is established between the sealing body and the shuttering frame in use so that it is fixed particularly well between the shuttering shell and the shuttering frame.

Moreover, it is contemplated that the width of the sealing surfaces in a direction perpendicular to the direction of extension is smaller than the width of the guide portions in a direction perpendicular to the direction of extension. In this embodiment, the sealing surfaces of the sealing body are smaller than the guide portions. If the sealing body is compressed in the area of the sealing surfaces a small sealing surface is already sufficient for a secure sealing between the shuttering shell and the shuttering frame. The guide portion, on the other hand, is provided to guide the shuttering shell and the shuttering frame during the mutual assembly. Therefore, a size or width of the guide portions comparable, in scale, to the thickness of the shuttering shell is particularly advantageous to ensure a good guidance over the largest possible area of the thickness the shuttering shell.

In one embodiment, it is contemplated that the mounting element is formed by an adhesive surface disposed on a portion of one of the abutment surfaces or on the second end face. In this embodiment, the mounting element has the effect of a material connection and is implemented as an adhesive surface. Such an adhesive surface may be directly applied to a portion of an abutment surface or an end face during the production of the sealing profile. Alternatively, such an adhesive surface may be provided by the mounting element being manually applied, for example, in the form of a double-sided adhesive tape prior to mounting the sealing body. An advantage of this embodiment is that no specially designed portion for a positive connection to the sealing profile has to be provided on the shuttering frame or the shuttering shell. This embodiment is therefore particularly suitable for retrofitting existing shuttering elements with a sealing profile.

Skillfully it is contemplated that the adhesive surface is disposed on one of the guide portions. The guide portions have a large surface area and are therefore a suitable attachment position for a mounting element implemented as an adhesive surface.

In one embodiment, it is contemplated that the mounting element is formed by a protrusion which protrudes beyond one of the abutment surfaces or the second end face. In this embodiment, the mounting element is formed by a protrusion which is provided for a positive and/or a non-positive connection to the shuttering frame or the shuttering shell. Such a protrusion may be disposed on an abutment surface or on an end face. The protrusion may have various shapes and either continuously extend on the sealing body along the direction of extension or have interruptions in the direction of extension. For example, the protrusion may be implemented as a fin extending in the direction of extension. Alternatively, the protrusion may, for example, have a cylindrical design and be arranged only in portions of the sealing profile along the direction of extension.

Skillfully, it is contemplated that the mounting element formed by a protrusion, at least in portions, is made of the same material as the sealing body. In this embodiment, at least part of the mounting element is made of the same material as the sealing body. In this way, the sealing profile can be produced together with the sealing body and the mounting element with little effort in one working cycle. However, it is possible that the protrusion is partly made of a material other than the sealing body and, for example, has a reinforcing inlay.

Moreover it is contemplated that the mounting element formed by a protrusion constitutes a common component together with the sealing body. In this embodiment, the mounting element and the sealing body are integrally formed. For example, the entire sealing profile may be made of a rubber material and produced in a single operation.

Advantageously, it is contemplated that at least one undercut provided for establishing a positive connection of the sealing profile to a component part is disposed between the mounting element formed by a protrusion and the adjoining surface of the sealing body. In this embodiment, an undercut provided for establishing a positive connection to the shuttering frame or the shuttering shell is disposed adjacent to or adjoining the protrusion. Here, an undercut is to be understood to be a cavity which is enclosed or covered by a portion of the protrusion at least in a direction perpendicular to the direction of extension. Such an undercut may be formed, for example, by the protrusion, in sections, having the shape of a dovetail in a cross-sectional view perpendicular to the direction of extension. Preferably, the protrusion is made of an elastic material so that a portion of the protrusion can be elastically deformed and introduced into a recess in the shuttering frame or the shuttering shell in this deformed state. Due to the elasticity, this portion of the protrusion will reassume its original shape after the introduction into the recess which results in that a positive connection is established between the recess or a portion adjacent to the recess and the protrusion.

Advantageously it is contemplated that the mounting element implemented as a protrusion extends continuously along the direction of extension. In this embodiment, the protrusion extends along the sealing body in the direction of extension without interruptions. In this way, a continuous attachment of the sealing profile to the shuttering frame or the shuttering shell is possible.

In an alternative embodiment, it is contemplated that the mounting element implemented as a protrusion has interruptions along the direction of extension and is particularly only arranged in sections of the sealing profile in the direction of extension. In this embodiment, the mounting element implemented as a protrusion is only arranged in sections of the sealing body along the direction of extension. Alternatively, likewise, a plurality of mounting elements implemented as a protrusion may be disposed on the sealing body along this direction. In this way, a smaller amount of material is required for forming the mounting element than in case of an embodiment in which the mounting element extends continuously along on the sealing body.

Moreover, it is contemplated that, in a cross-sectional view perpendicular to the direction of extension, the mounting element implemented as a protrusion has a larger width on its side facing away from the sealing body than on its side connected to the sealing body. In this embodiment, the width of the protrusion expands, starting from the sealing body, in a direction away from the sealing body. In this way, for example, an undercut can be produced between a portion of the protrusion and the sealing body. The width of the protrusion may change continuously or abruptly.

In an alternative embodiment, it is contemplated that the mounting element is formed by a cavity in the sealing body which, in the establishment of a connection to a component part, is provided for the positive accommodation of a portion of this component part. In this embodiment, the mounting element is formed by a, in sections, open cavity in the sealing body. Preferably, the sealing body is implemented so that it is elastic in the area of the cavity. For positively connecting the sealing profile to the shuttering frame or the shuttering shell, a protruding portion of the shuttering frame or the shuttering shell can be introduced into the elastic cavity. In this mounted state, the cavity will then enclose the protruding portion of the shuttering frame or the shuttering shell. In this way, in a functional reversal of the previously described embodiments, likewise, a positive connection can be established. Here, the cavity preferably has an undercut which interacts with an undercut disposed on the protruding portion of the shuttering frame or the shuttering shell. The cavity may also either extend continuously along the sealing body in the direction of extension or be provided only in portions of the sealing body.

Advantageously, it is contemplated that the sealing body has at least one hollow space in its interior. In this embodiment, a hollow space which is preferably filled with air is disposed in the interior of the sealing body. With such a hollow space, the rigidity of the sealing body is reduced as compared to a massively implemented sealing body. Such a reduced rigidity of at least portions of the sealing body renders a reduction of the mounting force during the installation of the shuttering shell in the shuttering frame possible. Preferably, such a hollow space is disposed between the guide portions and does not extend between the sealing surfaces. It is also possible to provide a plurality of hollow spaces which are either separate from each other or connected to each other through openings in the interior of the sealing body. The hollow space may extend continuously along the direction of extension or have interruptions in the direction of extension.

Skillfully, it is contemplated that the hollow space extends along the direction of extension and/or is connected to the surroundings of the sealing body by a connection opening extending through one of the abutment surfaces or one of the end faces. In this embodiment, the hollow space is connected to the surroundings of the sealing body by at least one connection opening. In this way, air present in the interior of the hollow space can escape during a compression of the sealing body. Therefore, the arrangement of a connection opening can be used to reduce the rigidity of the sealing body.

In one embodiment, it is contemplated that the sealing body has at least one recess which is disposed in one of the abutment surfaces or one of the end faces and interrupts one of these surfaces. In this embodiment, at least one recess is disposed on the outer side of the sealing body. Such a recess is an interruption of one of the abutment surfaces. Such a recess, in sections, reduces the thickness of the sealing body and thus its rigidity. It is also possible that a plurality of recesses is disposed in different positions on the sealing body. The provision of a recess results in reduced mounting forces required for mounting the shuttering shell in the shuttering frame owing to the reduced rigidity of the sealing body. Such a recess may also be an interruption of the mounting element. By providing a recess, the surface area of one of the abutment surfaces is reduced in its size.

Skillfully, it is contemplated that the recess is disposed in at least one of the guide portions, the recess interrupting the guide portion. In case of an arrangement of the recess in a guide portion, the sealing surface of an abutment surface is not interrupted so that a secure sealing is ensured. The arrangement in a guide portion reduces the size of its surface area and the rigidity of the sealing body in this area. In this way, the mounting forces for the installation of the shuttering shell in the shuttering frame can be reduced in a particularly effective way.

In one embodiment, it is contemplated that the sealing profile comprises at least one sensor which is implemented as a temperature sensor, a humidity sensor, a pressure sensor, a force sensor, or an expansion sensor. In this embodiment, at least one sensor is disposed in the or on the sealing profile. This sensor is provided to detect measured values or parameters which accrue in use during the erection of a building part. For example, a temperature sensor may be provided which is disposed adjacent to the concrete material filled into a shuttering. The temperature determined by such a temperature sensor allows for drawing conclusions on the hardening state of the concrete material. Based on the measured values from such a sensor, it can therefore be determined whether the filled-in concrete material has already sufficiently hardened to remove the shuttering element. This knowledge of the state of the concrete material renders a reduction of the process time on the construction site and therefore a more efficient work possible. Such a sensor may also be implemented as a pressure or force sensor which detects the pressure or the force exerted on the shuttering element by a filled-in concrete material. Particularly in the erection of building parts extending in the vertical direction over a large height, it has to be ensured that the pressure exerted on the shuttering will not become excessively high to avoid damage. A sensor arranged in the sealing profile assists in monitoring whether the shuttering element is subjected to loads within the permissible operating range. An advantage of the arrangement of a sensor on the or in the sealing profile is that it is protected against environmental impacts and against damage during the attachment and during the transport of the shuttering element. Furthermore, it is advantageous that such a sensor can be replaced together with the sealing profile or likewise retrofitted in existing shuttering elements in an easy manner. Therefore, this embodiment renders the extension of the shuttering element by additional functionalities possible in an easy manner. For obtaining relevant measured values from the sensor, it has to be appropriately and correctly positioned and connected. Usually, the assembly of a shuttering shell in a shuttering frame to a shuttering element is carried out by qualified staff. Therefore, it is ensured that the installation of the sealing profile in the shuttering element and therefore the installation of the sensor is carried out by qualified personnel. On the construction site on which the shuttering elements are deployed in use, it is frequently not ensured that qualified personnel is available. With the described embodiment, a shuttering element which is already professionally assembled is provided for on the construction site. In this way, it can be assumed that a sensor integrated in the sealing profile is correctly positioned and connected. An analysis of the detected measured values may be performed automatically so that, in use, no qualified technical staff has to be present on site. The described embodiment therefore provides for reliable measurement results and parameters during the erection of a building part.

Also disclosed is a sealing profile which extends along a direction of extension comprising:
at least one sealing body which, at least in portions, is made of an elastic material, the sealing body having at least two abutment surfaces, the abutment surfaces being disposed on opposite sides of the sealing body and extending parallel to the direction of extension, respectively, and each of the abutment surfaces being larger than the end faces of the sealing body disposed between the abutment surfaces, the sealing body having at least two sealing surfaces respectively one of which constitutes a portion of an abutment surface,
at least one mounting element, the mounting element being connected to the sealing body and particularly being disposed on one of the abutment surfaces,

the sealing profile comprising at least one sensor which is implemented as a temperature sensor, a humidity sensor, a pressure sensor, a force sensor, or an expansion sensor and which is disposed on the or in the sealing profile. Such a sealing profile is suitable for sealing a shuttering shell with respect to a shuttering frame of a shuttering element. However, such a sealing profile is also suitable for other applications in which two component parts are to be reliably sealed with respect to each other and in which, in addition, measured values are to be detected and analysed with the aid of at least one sensor.

In another embodiment of the shuttering element, it is contemplated that the sensor, at least in portions, is enclosed by the sealing body. In this embodiment, the sensor is, in portions, disposed inside the sealing body. The sensor may also be completely enclosed by the sealing body so that the sensor is optimally protected against environmental impacts. For example, a temperature sensor may be integrated in the sealing body in this way. Other sensor types such as, for example, a pressure sensor or a humidity sensor have to be in direct contact with the concrete material. These sensor types may be arranged so that they are, in portions, disposed on the surface of the sealing body.

In another embodiment, it is contemplated that the sensor, at least in portions, is disposed in one of the end faces or one of the sealing surfaces and interrupts one of these surfaces. In this embodiment, the sensor pierces the end face or one of the sealing surfaces. In this way, the sensor directly contacts the concrete material in use. In this way, a particularly precise detection of measured values and parameters is possible. It is also possible that a plurality of sensors is provided part of which are completely enclosed by the sealing body and another part of which is disposed so that they interrupt a surface of the sealing body.

In an alternative embodiment, it is contemplated that the sensor is disposed on one of the end faces or on one of the abutment surfaces. In this embodiment, the sensor is applied to a surface of the sealing body. For example, the sensor may be adhered to the outer side of an end face or an abutment surface. In this way, the attachment of the sensor to the sealing profile is possible in an easy manner. An end face is a particularly favourable attachment position since it will usually directly contact the concrete material in use.

Skillfully, it is contemplated that a plurality of sensors is disposed in the or on the sealing body. Said plurality of sensors may be sensors of the same type or sensors of different types. The provision of a plurality of sensors of the same type renders the measurement of a parameter in different positions on the shuttering element possible. It is also possible to redundantly provide a plurality of sensors of the same type so that, in case of a failure of a sensor, another sensor is available which detects the same measured values. When a plurality of sensors of different types is provided various parameters and measured values can be simultaneously detected.

Moreover, it is contemplated that the thickness of the sealing body, particularly between the abutment surfaces, is larger in a position in which, in the direction of extension, a sensor is disposed than the thickness of the sealing body in a position in which, in the direction of extension, no sensor is disposed. In this embodiment, the thickness of the sealing body varies in the direction of extension. In a position in which a sensor is disposed in the sealing profile it has a larger thickness than in other positions. Some sensor types have a larger design than the usual distance between the shuttering shell and the shuttering frame of a shuttering element. For rendering the arrangement of such a sensor type possible, the thickness of the sealing profile is locally increased. Accordingly, associated areas have to be provided on the shuttering frame or on the shuttering shell to render the accommodation of this thicker portion of the sealing profile possible. Such a sensor type having larger dimensions may be, for example, a pressure sensor.

Moreover, it is contemplated that the sensor has a sensor connection having a cable-based or wireless design. The sensor needs a connection connected to a control device or the like for transmitting the detected measured values or parameters. The sensor connection may be cable-based, in which case an associated cable may extend within the sealing body. Alternatively, the sensor connection may also be implemented so that it is wireless, for example as a radio sensor.

In one embodiment, it is contemplated that the dimension by which the frame edge protrudes beyond the contact surface is as large or larger than the thickness of the shuttering shell. In use, the shuttering shell is enclosed by the shuttering frame. Preferably, the shuttering frame is flush with the shaped surface of the shuttering shell in the mounted state to obtain a building part which is as planar as possible. In some embodiments, however, the shuttering shell has the tendency to swell in the direction of the thickness in the presence of moisture and to increase in its thickness in the process. In order to ensure that, in such a swelled state, the shuttering shell does not protrude beyond the shuttering frame, the shuttering element is preferably dimensioned so that the dimension by which the frame edge protrudes beyond the contact surface is larger than the thickness of a non-swelled shuttering shell. As a result of swelling, the shuttering shell changes in its thickness so that a relative movement relative to the shuttering frame occurs. Preferably, the sealing profile is implemented so that it will not move relative to the shuttering frame in case of a swelling of the shuttering shell. The change of dimensions caused by the swelling should only cause a relative movement among the shuttering shell and the sealing profile.

Moreover, it is contemplated that the shuttering shell is implemented in a plate shape and has a force transmission surface opposite of the shaped surface, the edge connecting the shaped surface to the force transmission surface. The force transmission surface of the shuttering shell abuts on the contact surface of the shuttering frame in use and transmits the loads transmitted to the shuttering shell by the concrete material on to the shuttering frame.

Moreover, it is favourably contemplated that the first sealing surface abuts on the frame edge in a sealing manner, and the second sealing surface abuts on the edge of the shuttering shell in a sealing manner. In this embodiment, respectively one sealing surface abuts on the shuttering shell and on the shuttering frame. In this state, the portion between the sealing surfaces is preferably elastically deformed. Preferably, one of the sealing surfaces abuts on a surface of the frame edge facing the shuttering shell, and another one of the sealing surfaces abuts on the edge of the shuttering shell.

In one embodiment, it is contemplated that, in a plan view of the shaped surface, the first end face is disposed between the shaped surface and the frame edge, and/or the second end face abuts on the contact surface or a surface of the shuttering frame disposed adjacent to it. In the mounted state of the shuttering element, the first end face connects the shaped surface of the shuttering shell to the frame edge. Here, the second end face which is disposed opposite of the first end face abuts on the contact surface of the shuttering frame or on a surface disposed adjacent to it.

Advantageously, it is contemplated that, in use, the sealing body, at least in portions, is elastically deformed between the shuttering frame and the shuttering shell. Such an elastic deformation results from the sealing body being implemented so that, in the unmounted state, it is thicker than the distance between the frame edge and the shuttering shell. In this way, the sealing body, at least in portions, is compressed and therefore elastically deformed during the assembly. This deformation results in the formation of a return force in the sealing body which presses the sealing body and particularly its sealing surfaces against the shuttering frame and the shuttering shell. In this way, a good sealing between the component parts is ensured. In some embodiments of a shuttering shell, the size of the shuttering shell changes parallel to the shaped surface in case of temperature fluctuations. This causes the distance between the edge of the shuttering shell and the frame edge to vary. The interposed sealing profile compensates this change in dimensions of the shuttering shell which is caused by temperature fluctuations. When the temperature increases the dimensions of the shuttering shell will increase, and the sealing profile is further elastically deformed or compressed. When the size of the shuttering shell decreases due to a temperature drop the elastic deformation of the sealing body is also reduced. The elastic deformation of the sealing body is adapted so that in any operating state, particularly at any ambient temperature, at least a portion of the sealing body is elastically deformed, and a secure sealing is in ensured this way.

In one embodiment, it is contemplated that the mounting element is disposed on the first abutment surface and connected to the frame edge. In this embodiment, the sealing profile is fixedly connected to the frame edge of the shuttering frame. This fixed connection is established before the shuttering shell is mounted in the shuttering frame. When the shuttering shell is removed the sealing profile remains connected to the frame edge.

Skillfully, it is contemplated that the mounting element is implemented as a protrusion, and that this protrusion is positively and/or non-positively introduced into a recess in the frame edge. In this embodiment, the mounting element implemented as a protrusion is introduced into a recess or opening in the frame edge. This connection may be positive, for example, by an undercut on the protrusion encompassing the edge portion of the recess on the frame edge. Alternatively or in addition, this connection may also be implemented so that it is non-positive by the protrusion being compressed during the insertion into the recess, and the protrusion being non-positively fixed in the recess by the elastic return force.

In another embodiment, it is contemplated that the mounting element is disposed on the second abutment surface and connected to the edge of the shuttering shell. In this embodiment, the sealing profile is fixedly connected to the edge of the shuttering shell. Prior to the installation of the shuttering shell in the shuttering frame, the sealing profile is connected to the shuttering shell and then mounted in the shuttering frame together with the same.

In an advantageous implementation, it is contemplated that the mounting element is implemented as a protrusion, and that this protrusion is positively and/or non-positively introduced into a recess in the edge of the shuttering shell. In this embodiment, an attachment of the sealing profile takes place by means of a mounting element implemented as a protrusion which is connected to a recess in the edge of the shuttering shell. In this embodiment, the sealing profile remains on the shuttering shell when the shuttering element is disassembled.

In another embodiment, it is contemplated that the surface of the frame edge oriented in the direction of the shuttering shell is disposed perpendicular to the contact surface, and that a first guide portion of the sealing profile is disposed at an angle with respect to a second guide portion of the sealing profile which results in the sealing body, at least in portions, being implemented in a wedge-shape, and the edge of the shuttering shell, at least in portions, being arranged at an angle of more than 90° with respect to the force transmission surface. In this embodiment, the surface of the frame edge oriented in the direction of the shuttering shell is perpendicular to the contact surface, the edge of the shuttering shell is implemented so that it is inclined, and the sealing profile has a sealing body which is implemented so that it is, at least in portions, wedge-shaped. The perpendicular arrangement of the surface of the frame edge oriented in the direction of the shuttering shell with respect to the contact surface corresponds to an embodiment of a shuttering frame which is frequently used in the prior art. An improved sealing as well as a centring effect during the installation of the shuttering shell in the shuttering frame is achieved by the interaction of a sealing body which, in portions, has a wedge-shaped design with the inclined edge of the shuttering shell. In this embodiment, the angle between the force transmission surface or the contact surface and the inclined edge is larger than 90° and is, for example, an angle α′ plus 90°. The guide portions of the sealing body are also arranged at an angle with respect to each other and correspond to, for example, an angle α. Here, the two angles α and α′ may be implemented so that they are identical. The thicker side of the wedge-shaped portion of the sealing body is oriented in the direction of the contact surface in the mounted state. In this way, the sealing body is positively confined between the frame edge and the inclined edge of the shuttering shell. Due to fact that the two angles α′ and a are identical, the inclined edge of the shuttering shell slides along the guide portion of the sealing body over a large surface area and with a secure guidance during the installation of the shuttering shell in the shuttering frame.

Skillfully it is contemplated that the edge of the shuttering shell, in an upper portion adjoining the shaped surface, is arranged at the angle α′ plus 90° with respect to the force transmission surface and, in a lower portion adjoining the upper portion, arranged at an angle of more than α′ plus 90° with respect to the force transmission surface. In this embodiment, the edge of the shuttering shell has different inclinations in two portions arranged one above the other. A first, upper portion adjoining the shaped surface is arranged at an angle of α′ plus 90° with respect to the force transmission surface or the contact surface. Preferably, the angle α between the guide portions of the sealing body is equal to the angle α′. In this way, an extensive abutment of the edge of the shuttering shell on the sealing body is ensured in this portion which results in a compression or elastic deformation of the sealing body in this portion and therefore provides for a secure sealing. In a lower portion of the edge of the shuttering shell, it is more inclined and therefore, in portions, spaced apart from the guide portion of the sealing body in the mounted state or during the assembly. In this way, the sliding friction between the edge of the shuttering shell and the guide portion during the assembly is reduced. In this way, the shuttering shell can be mounted in the shuttering frame with lower effort required as compared to a case in which the entire edge of the shuttering shell is oriented at an angle of α′ plus 90° with respect to the contact surface. Therefore, this embodiment, on the one hand, renders a reduction of the mounting force for the assembly of the shuttering shell possible and, on the other hand, provides for a centring effect of the shuttering shell in the shuttering frame during the assembly.

In an alternative embodiment, it is contemplated that the surface of the frame edge oriented in the direction of the shuttering shell is arranged at an angle of more than 90° with respect to the contact surface, and that a first guide portion of the sealing profile is arranged at an angle with respect to a second guide portion of the sealing profile so that the sealing body, at least in portions, has a wedge-shaped design, and the edge of the shuttering shell, at least in portions, is arranged perpendicular to the force transmission surface. In this embodiment, the surface of the frame edge facing the shuttering shell is implemented so that it is inclined, the sealing body, in portions, has a wedge-shaped design, and the edge of the shuttering shell is arranged so that it is not inclined but perpendicular to the contact surface and to the force transmission surface. In this embodiment, a centring effect is obtained between the inclined frame edge and the wedge-shaped portion of the sealing body during the installation of the shuttering shell in the shuttering frame. In this embodiment, preferably, the sealing profile is fixedly connected to the edge of the shuttering shell arranged perpendicular to the force transmission surface.

In an advantageous implementation, it is contemplated that the dimension of the sealing profile in a direction perpendicular to the contact surface is larger than or equal to the thickness of the shuttering panel between the shaped surface and the force transmission surface. In this embodiment, the height of the sealing profile in a direction perpendicular to the contact surface is at least equal to the thickness of the shuttering shell. In this way, the sealing body is clamped between the frame edge and the shuttering shell over its entire height in use. Since the shuttering shell, in some embodiments, tends to increase in thickness by swelling in use the height of the sealing profile is preferably implemented so that it is slightly larger than the thickness of the shuttering shell in an non-swelled state.

In an alternative embodiment, it is contemplated that the surface of the frame edge oriented in the direction of the shuttering shell is arranged at an angle of more than 90° with respect to the contact surface, and that a first guide portion of the sealing profile is arranged parallel to a second guide portion of the sealing profile so that the sealing body, at least in portions, has boundary surfaces extending parallel to each other respectively one of which abuts on the frame edge and on the edge of the shuttering shell, and the edge of the shuttering shell, at least in portions, is arranged at an angle of more than 90° with respect to the force transmission surface. In this embodiment, the surface of the frame edge oriented in the direction of the shuttering shell is inclined, the edge of the shuttering shell is inclined, and the sealing body of the sealing profile has two guide portions arranged parallel to each other. In this embodiment, the sealing body is therefore not wedge-shaped or otherwise implemented in a varying thickness. In this embodiment, a centring effect during the installation of the shuttering shell in the shuttering frame is achieved by the inclined surface of the frame edge facing the shuttering shell interacting with an edge of the shuttering shell preferably inclined in the same manner. Between these inclined surfaces, the sealing profile is disposed which has a constant thickness. Here, the sealing profile may either be fixedly connected to the frame edge or fixedly connected to the edge of the shuttering shell. In this embodiment, the sealing profile has a simpler shape than in the previously described embodiments and can therefore be produced at low cost. A secure sealing as well as a centration of the shuttering shell during the installation in the shuttering frame are provided for by inclined surfaces on the shuttering frame and on the edge of the shuttering shell.

Moreover, it is contemplated that the shuttering shell, in portions, is made of a wood-based material, particularly plywood, or, in portions, of a plastic material. Wood-based materials exhibit a high strength at a low weight. However, wood-based materials, particularly plywood, tend to increase in thickness by swelling in case of moisture absorption. However, plywood, due to its structure, hardly tends to change in its dimensions parallel to the shaped surface. Plastic materials exhibit a lower swelling behaviour, however, they tend to change their dimensions parallel to the shaped surface in case of temperature variations. However, both dimensional changes, both the ones of wood-based materials and the ones of plastic materials, can be compensated by the sealing profile arranged between the shuttering frame and the shuttering shell.

Skillfully, it is contemplated that the sealing profile comprises at least one sensor, the sensor being connected to a control device disposed on the or in the shuttering frame in a cable-based or wireless manner. In this embodiment, the sealing profile comprises a sensor for detecting measured values or parameters during the erection of a building part. Furthermore, a control device which communicates with the sensor and collects and analyses the measured values detected by the sensor is disposed on the shuttering frame or in the shuttering frame.

In an advantageous implementation, it is contemplated that the sealing profile comprises at least one sensor, the thickness of the sealing body, particularly between the abutment surfaces, being larger in a position in which a sensor is disposed in the direction of extension than the thickness of the sealing body in a position in which no sensor is disposed in the direction of extension, and the shuttering shell or the frame edge having a recess in the position in which the thickness of the sealing profile is larger due to the arrangement of a sensor, this recess, starting from the edge, extending into the shaped surface of the shuttering shell, or, starting from a surface of the frame edge facing the shuttering shell, extending into a surface of the frame edge arranged parallel to the contact surface. In this embodiment, the sealing profile comprises at least one sensor which has larger dimensions than the distance between the shuttering frame and the shuttering shell. For this reason, the thickness of the sealing body is larger in the position in which the sensor is disposed than in other positions. For accommodating these thicker portions of the sealing body, a recess is provided either in the frame edge or in the shuttering shell. During the assembly of the shuttering element, the thicker portion of the sealing profile including the sensor is positively introduced into this recess. In this way, the sensor is positioned so that it is embedded in the sealing profile between the shuttering frame and the shuttering shell. By embedding the sensor in the sealing profile, a secure sealing between the shuttering shell and the shuttering frame is also ensured in the area of the thicker portion. This embodiment is particularly suitable for the arrangement of a pressure sensor which can be used for determining the load produced by concrete material on the shuttering element.

In an alternative embodiment, it is contemplated that at least one sensor element is provided which includes at least one temperature sensor, humidity sensor, pressure sensor, force sensor, or expansion sensor, the sensor element being disposed between the force transmission surface of the shuttering shell and the contact surface of the shuttering frame. In this embodiment as well, at least one sensor is provided on the shuttering element. However, this sensor is not disposed in or on the sealing profile like in the previously described embodiments but is positioned between the force transmission surface of the shuttering shell and the contact surface of the shuttering frame. In this position, the load applied to the shuttering shell by the concrete material is transmitted on to the shuttering frame. In this embodiment, a sensor element is provided in this position which may be formed, for example, by a sensor pad disposed between the shuttering panel and the shuttering frame in the direction of action of force. Such a sensor element is particularly suitable for detecting measured values relating to the load on the shuttering shell and may, for example, include a pressure, force, or expansion sensor. It is also possible to arrange a plurality of different sensor types in a sensor element. Advantageous in this embodiment is that the sensor element is disposed between the shuttering shell and the shuttering frame in a direction perpendicular to the shaped surface and can therefore determine the normal force acting on the shuttering shell in an easy manner. In this embodiment as well, the sensor element including one or a plurality of sensors is disposed in the interior of the shuttering element in a protected manner.

Also disclosed is the use of a sealing profile for sealing a shuttering shell against a shuttering frame of a shuttering element for shuttering a building part, the sealing profile extending along a direction of extension comprising:
at least one sealing body which, at least in sections, is made of an elastic material, the sealing body having at least two abutment surfaces which, at least in portions, abut on the shuttering frame and/or the shuttering shell, the abutment surfaces being disposed on opposite sides of the sealing body and extending parallel to the direction of extension, respectively, and each of the abutment surfaces being larger than the end faces of the sealing body disposed between the abutment surfaces, the sealing body having at least two sealing surfaces, respectively one of which forms a portion of an abutment surface,
at least one mounting element which is connected to the shuttering frame or the shuttering shell, the mounting element being connected to the sealing body and particularly being disposed on one of the abutment surfaces.

The use of the sealing profile for sealing a shuttering shell with respect to a shuttering frame renders an improved sealing of existing shuttering elements possible. The sealing profile may be implemented in various ways. The features, effects, and properties of the sealing profile previously described in connection with the shuttering element are also applicable to the use of the sealing profile as disclosed.

The object of the invention is also solved by a method for assembling a shuttering element according to one of the previously described embodiments comprising the process steps of:
A) providing a shuttering frame which has a contact surface which, in use, the shuttering shell, in portions, abuts on, and the shuttering frame further having a frame edge which is disposed adjacent to and, at least in portions, extends around the contact surface, the frame edge protruding beyond the contact surface in a direction perpendicular to the contact surface,
B) providing a shuttering shell which, in use, rests with a shaped surface against a building part to be erected, and which has a force transmission surface disposed opposite of the shaped surface, an edge extending around the shuttering shell and connecting the shaped surface to the force transmission surface,
C) attaching a sealing profile to the frame edge of the shuttering frame or to the edge of the shuttering shell,
D) introducing the shuttering shell into the frame edge of the shuttering frame, the sealing profile positioning, particularly centring the shuttering shell with respect to the shuttering frame until the force transmission surface of the shuttering shell, in portions, abuts on the contact surface of the shuttering frame,
E) attaching the shuttering shell to the shuttering frame.

The method according to the invention serves to assemble a shuttering element according to one of the previously described embodiments and is preferably carried out in the indicated order of the process steps A) to E). The method can be carried out in the reverse order for disassembling the shuttering element.

In a first process step A), a shuttering frame having a circumferential frame edge is provided. Preferably, the method is carried out by qualified staff in a service workshop. During the preparation, the shuttering frame may be placed, for example, on a table or on the floor.

In a second process step B), a shuttering shell is prepared which has a shaped surface facing the concrete material in use, and a force transmission surface disposed opposite of the shaped surface. An edge of the shuttering shell extends around the shaped surface. Preferably, the shuttering shell has a plate-shaped design.

In a third process step C), a sealing profile is attached to either the frame edge or to the edge of the shuttering shell. For this attachment, the mounting element of the sealing profile is used. The embodiment of the sealing profile, and particularly the attachment position of the mounting element on its sealing body determines whether the sealing profile is attached to the shuttering frame or to the shuttering shell.

In a fourth process step D), the shuttering shell is introduced into the frame edge of the shuttering frame and thereby mounted in the shuttering frame. This introduction is completed when the force transmission surface of the shuttering shell abuts on the contact surface of the shuttering frame. During the implementation of process step D), the sealing profile achieves a positioning of the shuttering shell relative to the shuttering frame in a plane parallel to the shaped surface of the shuttering shell. Preferably, the sealing profile is centred in this process step and guides the shuttering shell during the assembly so that, in the end of process step D), the distance between the edge of the shuttering shell and the frame edge is substantially constant around the shaped surface.

In a fifth process step E), the shuttering shell is attached to the shuttering frame which may be carried out, for example, by means of associated mounting elements known from prior art.

The method according to the invention is advantageous in that it can be carried out more easily and faster than the installation and sealing of a shuttering element with the aid of a liquid sealing material injected between the shuttering shell and the shuttering frame used in the prior art. In addition, the method according to the invention ultimately yields a shuttering element in which the sealing of the shuttering shell with respect to the shuttering frame is improved by a specially designed sealing profile. Particularly in case of an attachment of the sealing profile to the frame edge in process step C), the method according to the invention may also be used for replacing a shuttering shell, for example, in case of wear of the shaped surface, for repairing a shuttering element.

In one embodiment of the method, it is contemplated that, in process step D), the sealing profile, at least in portions, is deformed. As a result of such a compression and/or elastic deformation of the sealing profile, an elastic return force is generated in the same which presses sections of the sealing profile against the shuttering frame and the shuttering shell. In this way, a long-term stable, high-quality sealing between the shuttering shell and the shuttering frame is obtained.

The features, effects, and advantages disclosed in connection with the shuttering element are also deemed disclosed in connection with the method. The same applies in the reverse direction; features, effects, and advantages disclosed in connection with the method are also deemed disclosed in connection with the shuttering element.

### BRIEF DESCRIPTION OF THE DRAWINGS

In the Figures, embodiments of the invention are schematically illustrated. Here,

FIG. 1 shows a plan view of an embodiment of a shuttering element according to the invention,

FIG. 2 shows a cross-sectional front view of a portion of the embodiment of a shuttering element according to the invention illustrated in FIG. 1,

FIG. 3 shows a first embodiment of a sealing profile in a cross-sectional view transverse to the direction of extension,

FIG. 4 shows a second embodiment of a sealing profile in a cross-sectional view transverse to the direction of extension,

FIG. 5 shows a third embodiment of a sealing profile in a cross-sectional view transverse to the direction of extension,

FIG. 6 shows a cross-sectional front view of a portion of another embodiment of a shuttering element according to the invention,

FIG. 7 shows a cross-sectional front view of a portion of another embodiment of a shuttering element according to the invention,

FIG. 8 shows a cross-sectional front view of a portion of another embodiment of a shuttering element according to the invention,

FIG. 9 shows a cross-sectional front view of a portion of another embodiment of a shuttering element according to the invention,

FIG. 10 shows a fourth embodiment of a sealing profile in a cross-sectional view transverse to the direction of extension,

FIG. 11 shows a fifth embodiment of a sealing profile in a cross-sectional view transverse to the direction of extension,

FIG. 12 shows a sixth embodiment of a sealing profile in a cross-sectional view transverse to the direction of extension,

FIG. 13 shows a seventh embodiment of a sealing profile in a cross-sectional view transverse to the direction of extension,

FIG. 14 shows an eighth embodiment of a sealing profile in a cross-sectional view transverse to the direction of extension,

FIG. 15 shows a nineth embodiment of a sealing profile in a cross-sectional view transverse to the direction of extension,

FIG. 16 shows an embodiment of a sealing profile including sensors in a side view and a cross-sectional view transverse to the direction of extension,

FIG. 17a shows a cross-sectional front view of a portion of another embodiment of a shuttering element according to the invention including a sealing profile with sensors,

FIG. 17b shows a plan view of a portion of the embodiment of a shuttering element illustrated in FIG. 17a,

FIG. 18a shows a cross-sectional front view of a portion of another embodiment of a shuttering element according to the invention including a sealing profile comprising sensors,

FIG. 18b shows a plan view of a portion of the embodiment of a shuttering element illustrated in FIG. 18a.

### DETAILED DESCRIPTION

In the Figures, identical elements are designated by the same reference numerals. Generally, the described properties of an element described with reference to one Figure also apply to the other Figures. Directional information such as above or below relate to the described Figure and are to be applied to the other Figures according to their meaning.

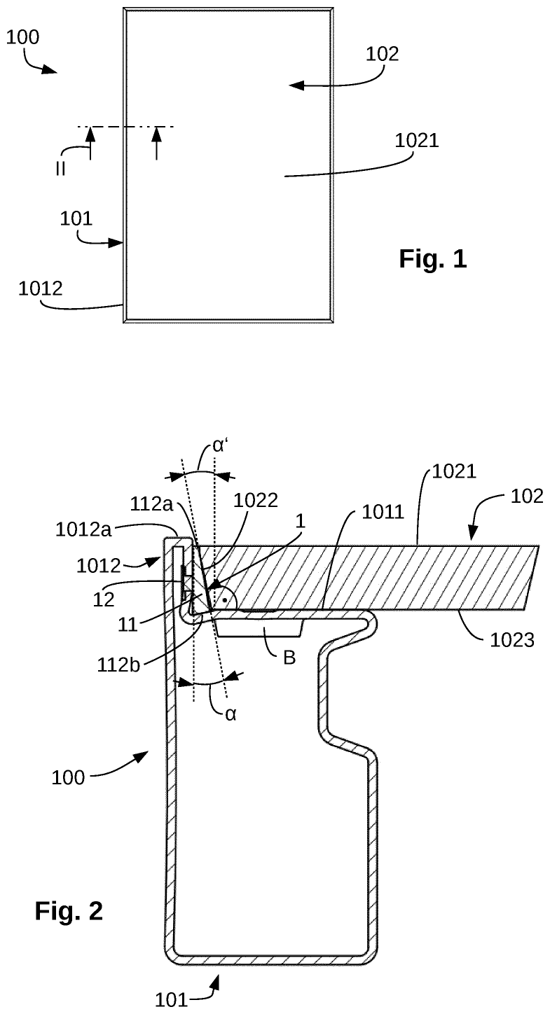

FIG. 1 shows a plan view of an embodiment of a shuttering element 100 according to the invention. The shuttering element 100 comprises a shuttering frame 101 which, in the illustrated plan view, supports a shuttering shell 102 illustrated in the centre. The surface of the shuttering shell 102 facing the observer is the shaped surface 1021 which, in use, abuts on a building part to be erected or on a concrete material poured into the shuttering. The shuttering frame 101 is, for the most part, disposed below the shuttering shell 102. In the illustration, only the frame edge 1012 of the shuttering frame 101 can be seen which completely surrounds the shaped surface 1021 of the shuttering shell 102. It is also possible that the frame edge 1012 is only arranged around the shaped surface 1021 in a portion of the circumference. In the illustrated plan view, a likewise circumferential sealing profile 1 sealing the shuttering shell 102 with respect to the shuttering frame 101 is inserted between the frame edge 1012 and the shuttering shell 102. The indicated sectional plane II is the sectional plane in FIG. 2.

FIG. 2 shows a cross-sectional front view of a portion of the embodiment of a shuttering element 100 according to the invention illustrated in FIG. 1. The illustration shows a cross section of a portion in the sectional plane II illustrated in FIG. 1. In FIG. 2, it can be seen that the shuttering frame 101 is formed by a metal profile which extends into the sectional plane in the illustration. The shuttering frame 101 has a hollow design inside. In the illustrated implementation of the shuttering frame 101 as a metal profile, a high load capacity at an, at the same time, low weight is ensured. On the side of the shuttering frame 101 facing upwards in the illustration, the contact surface 1011 is disposed. The shuttering shell 102 is placed on this contact surface 1011. In the illustration, the shaped surface 1021 of the shuttering shell 102 faces upwards and has a planar design. The shuttering shell 102 may be formed, for example, by a plywood plate which is preferably coated on the shaped surface 1021 to prevent concrete material from adhering. Opposite of the shaped surface 1021, the shuttering shell 102 has a force transmission surface 1023 which abuts on the contact surface 1011 in the illustrated state. In the illustrated embodiment, the shaped surface 1021 and the force transmission surface 1023 are arranged parallel to each other. The circumferential edge 1022 connects the shaped surface 1021 to the force transmission surface 1023. In the illustrated embodiment, the edge 1022 is implemented so that it is inclined with respect to the force transmission surface 1023 and therefore also with respect to the contact surface 1011. The edge 1022 is arranged at an angle other than 90° with respect to the contact surface 1011. This inclined implementation of the edge 1022, together with the sealing body 11 implemented in a wedge-shape in the illustrated embodiment, causes a centration of the shuttering shell 102 during the assembly with the shuttering frame 101. In the illustrated embodiment, the angle between the contact surface 1011 and the edge 1022 is 90° plus the angle α′. Adjacent to the contact surface 1011, the shuttering frame 101 has a frame edge 1012. This frame edge 1012 is implemented as a portion of the metal profile forming the shuttering frame 101. The frame edge 1012 protrudes beyond the contact surface 1011 in a direction perpendicular to the contact surface 1011. The frame edge has an end face 1012a facing upwards in the illustration which is implemented so that it is parallel to the contact surface 1011 and to the shaped surface 1021. The frame edge 1012 also has a surface facing the shuttering shell 102 which, in the illustrated embodiment, is oriented at right angles to the contact surface 1011. This surface of the frame edge 1012 facing the shuttering shell 102 has a planar design. In the illustrated embodiment, the distance between the contact surface 1011 and the end face 1012a is slightly larger than the thickness of the shuttering shell 102 between the shaped surface 1021 and the force transmission surface 1023. Preferably, the distance between the contact surface 1011 and the end face 1012a is equal to zero in use, i.e., during the erection of a building part. In this state, the end face 1012a and the shaped surface 1021 are flush with each other. However, in case of an implementation of the shuttering shell 102 as a plywood plate, usually swelling occurs in use so that the thickness of the shuttering shell 102 increases. This swelling is taken into consideration in the illustrated embodiment by the shuttering shell 102 being implemented so that it is slightly thinner than the distance between the contact surface 1011 and the end face 1012a. When swelling has occurred in use, it can therefore be assumed that the shaped surface 1021 and the end face 1012a are flush with each other. The shuttering shell 102 is connected to the shuttering frame 101 by means of a plurality of mounting members B. The mounting member B may be implemented, for example, as a screw which, starting from the interior space of the shuttering frame 101, is screwed through the contact surface 1011 into the force transmission surface 1023. The mounting member B pulls shuttering shell 102 towards the contact surface 1011 and fixes the two elements to each other. The mounting member B may be implemented in different ways and, apart from the mentioned example of an implementation as a screw, may also be implemented, for example, as a clip connection, a nail connection, an adhesive connection, or the like. For securely fixing the shuttering shell 102 in or on the shuttering frame 101, preferably, mounting members B are disposed in a plurality of positions. Preferably, the mounting members B are implemented so that they can be removed without being damaged so that a replacement of the shuttering shell 102 is possible in an easy manner.

A sealing profile 1 is disposed between the surface of the frame edge 1012 facing the shuttering shell 102 and the circumferential edge 1022 of the shuttering shell 102. The sealing profile 1 seals the clearance between the shuttering shell 102 and the frame edge 1012. In the illustrated, mounted state of the shuttering element 100, the sealing profile 1, particularly its sealing body 11, is elastically deformed and compressed as compared to a non-mounted state. As a result of this elastic deformation, an elastic return force is produced in the sealing profile 1 which presses the sealing profile 1 against the shuttering shell 102 and the shuttering frame 101. In this way, a secure and high-quality sealing between the two elements is ensured. The sealing profile 1 is illustrated in an enlarged scale in FIG. 5. The sealing profile 1 comprises a sealing body 11 implemented so that it is substantially wedge-shaped in the illustrated embodiment, and a mounting element 12 oriented towards the left in the illustration which is positively connected to the frame edge 1012. In the illustrated embodiment, the sealing body 11 is entirely made of an elastic material. The sealing body 11 has the two abutment surfaces 111a and 111b which are disposed on opposite sides of the sealing body 11. The first one of these abutment surfaces 111a extensively abuts on the surface of the frame edge 1012 facing the shuttering shell 102. The second abutment surface 111b extensively abuts on the edge 1022 of the shuttering shell 102. Moreover, the sealing body 11 is delimited by two end faces 112a and 112b on the top and bottom in the illustration. The abutment surfaces 111a and 111b are larger than the end faces 112a and 112b. The first end face 112a is arranged substantially parallel to the shaped surface 1021 and connects the shaped surface 1021 to the frame edge 1012. The second end face 112b abuts on a transition surface of the shuttering frame 101 which is disposed between the contact surface 1011 and the surface of the frame edge 1012 facing the shuttering shell 102. This transition surface, in portions, is set back with respect to the contact surface 1011. In the illustrated embodiment, the sealing profile 1 is connected to the shuttering frame 101 by means of the mounting element 12. The edge 1022 of the shuttering shell 102 only abuts on and is pressed against the sealing profile 1. A fixed connection between the sealing profile 1 and the shuttering shell 102 is not present in the illustrated embodiment. The mounting element 12 of the sealing profile 1 is positively connected to the frame edge 1012. For details relating to the mounting element 12, the description with reference to FIG. 5 is made reference to. The sealing between the shuttering shell 102 and the shuttering frame 101 is performed by two sealing surfaces 113a and 113b on the sealing body 11 which respectively form portions of the abutment surfaces 111a and 111b. For details relating to the sealing surfaces 113a and 113b, the enlarged illustration of the sealing profile 1 in FIG. 5 is made reference to. The two sealing surfaces 113a and 113b are arranged parallel to each other. The first sealing surface 113a flatly abuts on the surface of the frame edge 1012 facing the shuttering shell 102. The second sealing surface 113b, at least in portions, abuts on the edge 1022 of the shuttering shell 102. The two sealing surfaces 113a and 113b ensure a sealing between the shuttering shell 102 and the shuttering frame 101 directly adjacent to the shaped surface 1021. In this way, no concrete material can enter between the shuttering shell 102 and the shuttering frame 101 or the sealing profile 1 in use. For such sealing, it is sufficient that, adjacent to the shaped surface 1021 and the surface of the frame edge 1012 facing the shuttering shell, sealing takes place by means of the sealing surfaces 113a and 113b. It is not essential that the entire abutment surfaces 111a and 111b extensively abut on the frame edge 1012 and the edge 1022. For ensuring an easy mountability of the shuttering shell 102 in the shuttering frame 101, it may even be advantageous that a larger portion of one or both abutment surfaces 111a and 111b does not abut on the shuttering frame 101 or the shuttering shell 102. Below the two sealing surfaces 113a and 113b in the illustration, two guide portions 114a and 114b are disposed which also form portions of the abutment surfaces 111a and 111b, respectively. These guide portions 114a and 114b serve to guide the shuttering frame 101 and the shuttering shell 102 during the assembly of these elements. In the illustrated embodiment, the first guide portion 114a is arranged at an angle α with respect to the second guide portion 114b. The two guide portions 114a and 114b have a planar design. In this way, the portion of the sealing body 11 located between the two guide portions 114a and 114b has a wedge-shaped design. This wedge-shaped portion interacts with the inclined edge 1022 of the shuttering shell 102 during the installation of the shuttering shell 102 in the shuttering frame 101. The angle α is preferably 5° to 20°. In a simple embodiment, the angle α may be selected so that it is equal to the angle α′ which, added to 90°, defines the inclination of the edge 1022 of the shuttering shell 102. In this embodiment, the entire second guide portion 114b abuts on the edge 1022 in the mounted state. In this way, an abutment surface having a large surface area is ensured between shuttering shell 102 and sealing body 11, the sealing body 11 being elastically deformed in a large section in the installed state. In this embodiment, it may be disadvantageous that, in the assembly during the introduction of the shuttering shell 102 into the shuttering frame 101, high frictional forces occur due to the large abutment surface. These frictional forces may result in an undesired deformation of or damage to the sealing profile 1. For reducing the friction during the assembly, the angle α′ may be implemented so that it is larger than the angle α. This embodiment is illustrated in FIG. 2. It can be seen that, particularly in the vicinity of the contact surface 1011, there is a small distance between the sealing body 11 and the edge 1022. This wedge-shaped distance is caused by the angular difference between the angles α′ and the angle α. The abutment surface between the edge 1022 and the guide portion 114b is reduced by this wedge-shaped distance. In this way, the shuttering shell 102 can be mounted in the shuttering frame 101 while overcoming lower frictional forces. However, the difference between the two angles α′ and α is selected so that it is small and is preferably 0.1° to 5°. In this way, the two angles α′ and α, in interaction, still act as a centration during the installation of the shuttering shell 102 in the shuttering frame 101. In the illustrated embodiment, the sealing body 11, in portions, has a wedge-shaped design, the broader side of the wedge being disposed below, adjacent to the contact surface 1011. Therefore, the sealing body 11, starting from the shaped surface 1021, broadens towards the bottom in the illustration. Apart from the previously described effect of a centration of the shuttering shell 102 during the installation in the shuttering frame 101, such a wedge shape of a portion of the sealing body 11 has the effect that it is positively confined between the inclined edge 1022 of the shuttering shell 102 and the frame edge 1012. In this way, the sealing profile 1 is prevented from being pulled out of its position between the shuttering frame 101 and the shuttering shell 102 in use. In use, it may occur that concrete material adheres to the first end face 112a. When the shuttering element is separated from the erected building part, a force acts on the sealing body 11 which, starting from the shaped surface 1021, is directed upwards. The wedge shape of the sealing body 11 results in that it is positively retained in this direction perpendicular to the shaped surface 1021. Therefore, it is ensured that the sealing between the shuttering shell 102 and the shuttering frame 101 is long-term stable even in use. Such an effect of the positive fixation of the sealing body 11 between the shuttering shell 102 and the shuttering frame 101 is also given in the embodiments of FIGS. 6, 9, 16a, and 17a.

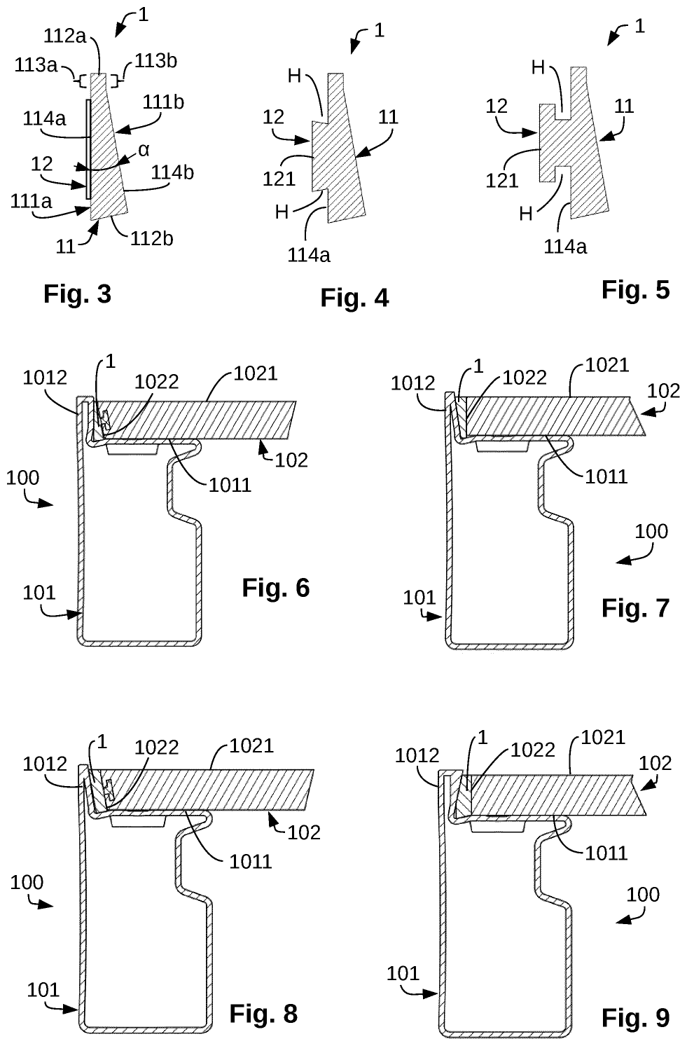

The embodiments of a sealing profile 1 shown in FIGS. 3 to 5 are provided for an attachment to the shuttering frame 101.

FIG. 3 shows a first embodiment of a sealing profile 1 in a cross-sectional view transverse to the direction of extension ER. The direction of extension ER extends into the drawing plane in the illustration. The illustrated embodiment of a sealing profile 1 constantly has the shown cross section in the direction of extension ER. In the cross-sectional view, the, in portions, wedge-shaped sealing body 11 to which, on the left side, a mounting element 12 in the form of an adhesive surface is attached can be seen on the right side. The sealing body 11 has a massive design and is exclusively made of an elastic material, for example, rubber. On the left side in the illustration, a first abutment surface 111a is disposed, on the right side, a second abutment surface 111b is disposed. Both abutment surfaces 111a and 111b extend in the vertical direction over the entire height of the sealing body 11. On the upper side in the illustration, a first end face 112a is located, on the lower side of the sealing body, a second end face 112b is disposed. The two abutment surfaces 111a and 111b, together with the two end faces 112a and 112b, form the entire circumference around the sealing body in the shown cross-sectional view. Adjacent to the first end face 112a, the two sealing surfaces 113a and 113b are located which extend parallel to each other. The first sealing surface 113a constitutes a portion the first abutment surface 111a, and the second sealing surface 113b constitutes a portion of the second abutment surface 111b. The portion of the sealing body 11 below the sealing surfaces 113a and 113b has a wedge-shaped design. In the illustrated embodiment, the portion of the first abutment surface 111a in which the sealing surface 113a is not disposed forms a first guide portion 114a. Accordingly, the portion of the second abutment surface 111b in which the sealing surface 113b is not disposed forms a second guide portion 114b. The two guide portions 114a and 114b have a planar design and are oriented at an angle α with respect to each other. The effect of the sectional wedge shape of the sealing body 11 is described in connection with FIG. 2. In the illustrated embodiment, the first sealing surface 113a directly adjoins the first guide portion 114a, and the second sealing surface 113b directly adjoins the second guide portion 114b. However, it is also possible that, between a sealing surface 113a, 113b and a guide portion 114a, 114b, another portion of the abutment surface 111a, 111b separating the sealing surface 113a, 113b and the guide portion 114a, 114b from each other is disposed, respectively. Furthermore, it is also possible that the sealing surfaces 113a and 113b are not arranged parallel to each other but at an angle to each other. The first end face 112a is arranged at right angles to the two sealing surfaces 113a and 113b. This embodiment of a sealing body 11 is, for example, well suited for sealing a shuttering element 100 as shown in FIG. 2. In the mounted state, the first end face 112a further contacts concrete material introduced into the shuttering in use. For this reason, a parallel or particularly flush arrangement of the first end face 112a to/with the shaped surface 1021 is advantageous in the mounted state. In this embodiment, the transition between the shuttering frame 101 and the shuttering shell 102 will then be even on the finished erected building part and will, in this way, provide for an optically pleasant appearance. In the illustrated embodiment, the second end face 112b is arranged at an angle of less than 90° to the first abutment surface 111a and at an angle of more than 90° to the second abutment surface 111b. This results in that the first abutment surface 111a is longer than the second abutment surface 111b in the vertical direction. This embodiment is particularly suitable for the introduction into a shuttering frame 101 according to the embodiment as shown in FIG. 2. The protruding tip in the position in which the first abutment surface 111a and the second end face 112b adjoin can be introduced into the set-back transition area between the contact surface 1011 and the surface of the frame edge 1012 oriented towards the shuttering shell. In this way, the sealing body 11 is positively fixed between the frame edge 1012 and the contact surface 1011 of the shuttering frame. Of course, the second end face may also be oriented at another angle, for example, at the right angle to the first abutment surface 111a. In the illustrated embodiment, the thickness of the sealing profile 1 or of the sealing body 11 varies in size in the vertical direction in the illustration. As a result of a varying thickness in this direction which also corresponds to a direction which is oriented perpendicular to the contact surface 1011 in the mounted state of the sealing profile, a centration of the shuttering shell 102 can be achieved during the installation in the shuttering frame 101. For this purpose, it is not strictly required that, as illustrated in FIG. 3, the sealing body 11, in sections, has a wedge-shaped design. A varying thickness in the vertical direction may also be obtained by a curved design of one or both abutment surfaces 111a and 111b. In addition, an abrupt increase in the thickness in the vertical direction may also achieve a centring effect for the installation of the shuttering shell 102 in the shuttering frame 101. In the illustrated embodiment, the thickness of the sealing body 11 is larger on the lower side, i.e., in the mounted state, adjacent to the contact surface 1011, than the thickness on the upper side, i.e., in the mounted state, adjacent to the shaped surface 1021. It is also possible to implement the sealing body 11 so that its thickness is larger on the upper side than its thickness on the lower side. When interacting with a correspondingly shaped frame edge 1012 a centring effect can also be obtained in this alternative embodiment. Such a case is illustrated, for example, in FIG. 7.

In the embodiment illustrated in FIG. 3, the mounting element 12 is formed by an adhesive surface which is disposed on a portion of the first abutment surface 111a. The adhesive surface is disposed on the first guide portion 114a. The adhesive surface may be applied to the sealing body 11, for example, during the production of the sealing profile 1. Alternatively, it is possible to only apply the adhesive surface during the installation of the sealing body 11 on the shuttering frame 101 or on the shuttering shell 102, for example, by means of a double-sided adhesive tape. For the material attachment, the sealing profile 1 together with the adhesive surface is either pressed against the surface of the frame edge 1012 facing the shuttering shell 102 or against the edge 1022 of the shuttering shell 102.

FIG. 4 shows a second embodiment of a sealing profile 1 in a cross-sectional view transverse to the direction of extension ER. The sealing body 11 disposed on the right side of the embodiment illustrated in FIG. 4 is identical in design to the sealing body 11 of the embodiment of FIG. 3. However, the mounting element 12 of the embodiment illustrated in FIG. 4 differs from the mounting element in FIG. 3. In the embodiment illustrated in FIG. 4, the mounting element is formed by a protrusion which is disposed on the first abutment surface 111a, particularly on the first guide portion 114a, and protrudes beyond the first abutment surface 111a. In the illustrated embodiment, this protrusion 121 is made of the same elastic material as and forms a common component together with the sealing body 11. Adjacent to the protrusion 121, two undercuts H are disposed which are located between the protrusion 121 and the first mounting portion 114a on which the protrusion 121 is disposed. In the cross-sectional view, it can be seen that the protrusion 121 has the shape of a dovetail. The two undercuts H are provided to be positively connected to a complementary shaped portion of the shuttering frame, particularly of the frame edge 1012. Such a portion on the frame edge 1012 which is complementary in shape may be formed, for example, by a slit which has the same width as the protrusion on its transition area to the first guide portion 114a. During the introduction of the mounting element 12 into such a slit, the protrusion 121 is first elastically deformed in the edge portion. After the introduction, the edge portion of the slit is located in the two undercuts, and the remaining protrusion establishes a positive connection to the slit and thus the frame edge 1012 due to the elastic deformation back into the original state. In the illustrated embodiment, the protrusion 121 extends along the direction of extension ER into the drawing plane in a constant shape.

FIG. 5 shows a third embodiment of a sealing profile 1 in a cross-sectional view transverse to the direction of extension ER. In the embodiment illustrated in FIG. 5, the sealing body 11 is also identical in design to the embodiment which is illustrated in FIG. 3. Therefore, the description with reference to FIG. 3 is made reference to for the description of the sealing body 11. The embodiment illustrated in FIG. 5 comprises a mounting element 12 implemented as a protrusion 121. The protrusion 121 is disposed on the first guide portion 114a and protrudes beyond the first abutment surface 111a. In this embodiment as well, two undercuts H provided for the positive connection to the shuttering frame 101 are disposed between the protrusion 121, or at least portions of the protrusion 121, and the first abutment surface 111a. In the illustrated cross-sectional view, the two undercuts H have a rectangular cross section. In the illustrated embodiment, the protrusion 121 has interruptions along the direction of extension ER and is disposed on the sealing body 11 only in sections in this direction. In the illustrated embodiment, therefore, a plurality of protrusions 121 is installed on the sealing body 11 along the direction of extension ER. In a view as regarded from the left in FIG. 5, these protrusions 121 may have a, for example, circular shape. For establishing a positive connection to the shuttering frame 101, for example, corresponding circular openings into which the protrusions 121 are pushed during the installation of the sealing profile 1 may be provided on the frame edge 1012. Such an embodiment is illustrated in FIG. 2. The protrusions 121 made of an elastic material are pushed through a circular opening in the surface of the frame edge 1012 facing the shuttering shell 102. Here, the undercuts H engage around the edge the circular openings, the part of the protrusion 121 oriented towards the left in FIG. 5 abuts on the side of a portion of the frame edge 1012 facing away from the sealing body and positively fixes the sealing profile 101 to the shuttering frame 101 in this way. It is also possible, to constantly arrange the embodiment of a protrusion 121 shown in FIG. 5 along the direction of extension ER.

In FIG. 6 to FIG. 9, other embodiments of a shuttering element 100 are illustrated. The sectional plane for these illustrations corresponds to the sectional plane II which is indicated in FIG. 1. The embodiments of FIG. 6 to FIG. 9 differ from each other in the interaction of the elements frame edge 1012, sealing profile 1, and shuttering shell 102. Unless described otherwise, the description with reference to FIG. 2 is made reference to, particularly with regard to the details of the shuttering frame 101 and the shuttering shell 102.

FIG. 6 shows a cross-sectional front view of a portion of another embodiment of a shuttering element 100 according to the invention. In the illustrated embodiment, the sealing profile 1 is connected to the shuttering shell 102 by means of its mounting element 12. Details on the sealing profile 1 are illustrated in and described in connection with FIG. 12. The surface of the frame edge 1012 facing the shuttering shell 102 is oriented at right angles to the contact surface 1011. A portion of the sealing body 11 has a wedge-shaped design. The edge 1022 of the shuttering shell 102 is implemented so that it is inclined. The sealing body 11 is formed so that its thickness, particularly the distance between its two abutment surfaces 111a and 111b, increases from the top to the bottom in the illustration in a direction perpendicular to the contact surface 1011. The inclination of the edge 1022 of the shuttering shell 102 is, correspondingly, implemented so that it is complementary in shape to the wedge shape of the sealing body 11. Due to the fact that the thickness of the sealing body 11 adjacent to the contact surface 1011 is larger than the thickness of the sealing body 11 adjacent to the shaped surface 1021, the sealing profile 1 is positively fixed by the inclination of the edge 1022 between the shuttering shell 102 and the shuttering frame 101 in a direction perpendicular to the contact surface 1011. In the illustrated embodiment, the inclined edge 1022 and the sealing profile 1 are fixedly connected to each other prior to the installation of the shuttering shell 102 in the shuttering frame 101. Therefore, the inclined edge 1022 does not provide for a centration in combination with the wedge shape of the sealing profile 1 during the installation of the shuttering shell 102 in the shuttering frame 101. However, a centring effect during the assembly is achieved by the sealing body 11, on its side facing away from the shaped surface 1021, being elastically deformed at the beginning of the assembly, this deformation temporarily also resulting in a wedge shape and therefore a centring effect. After the completion of the assembly, the state illustrated in FIG. 6 ensues in which this lower portion of the sealing body 11 has elastically undeformed and is fixed between the frame edge 1012 and the shuttering shell 102.

FIG. 7 shows a cross-sectional front view of a portion of another embodiment of a shuttering element 100 according to the invention. In this embodiment, the surface of the frame edge the 1012 oriented in the direction of the shuttering shell 102 is implemented at an angle other than 90° with respect to the contact surface 1011 and therefore inclined. The sealing body 11 has a wedge-shaped design and is fixedly connected to the edge 1022 by a mounting element 12 implemented as an adhesive surface. A sealing profile 1 which can be seen in FIG. 7 is illustrated in detail in FIG. 9. In contrast to the embodiments of FIG. 2 and FIG. 6, the thickness of the sealing body 11 is larger on its side facing the shaped surface 1021 than on its side facing the contact surface 1011 in the embodiment of FIG. 7. The wedge shape of the sealing body 11 is implemented so that it is complementary to the inclination of the surface of the frame edge 1012 facing the shuttering shell 102. In the illustrated embodiment, a centration during the installation of the shuttering shell 102 in the shuttering frame 101 is achieved by the first abutment surface 111a which is implemented so that it is inclined with respect to the contact surface 1011 sliding along the likewise inclined surface of the frame edge 1012 facing the shuttering shell 102 so that the shuttering shell 102 is centred with respect to the frame edge 1012 during the assembly. In this embodiment, the edge 1022 of the shuttering shell 102 is disposed at right angles to the shaped surface 1021 and to the contact surface 1011. Of course, the sealing profile 1 may also comprise a mounting element 12 implemented as a protrusion 121 engaging in a recess in the edge 1022 which is, correspondingly, implemented so that it is complementary in shape in the illustrated embodiment.

FIG. 8 shows a cross-sectional front view of a portion of another embodiment of a shuttering element 100 according to the invention. In the embodiment illustrated in FIG. 8, both the surface of the frame edge 1012 oriented in the direction of the shuttering shell 102 and the edge 1022 of the shuttering shell 102 are implemented at an angle other than 90° to the contact surface 1011 and therefore inclined. In the illustrated embodiment, the sealing body 11 has a substantially constant thickness between its two abutment surfaces 111a and 111b. The sealing profile 1 is positively and fixedly connected to the edge 1022 by a mounting element implemented as a protrusion 121. During the installation of the shuttering shell 102 in the shuttering frame 101, the first contact surface 111a of the sealing body 11 oriented towards the left and the surface of the frame edge 1012 facing the shuttering shell 102 interact and centre the shuttering shell 102 with respect to the shuttering frame 101 due to their inclined arrangement. In the illustrated embodiment, the two guide portions 114a and 114b of the sealing body 11 are oriented parallel to each other.

FIG. 9 shows a cross-sectional front view of a portion of another embodiment of a shuttering element 100 according to the invention. In this embodiment, the surface of the frame edge 1012 facing the shuttering shell 102 is disposed at an angle other than 90° to the contact surface 1011. In the embodiment of FIG. 9, this surface of the frame edge 1012 facing the shuttering shell 102 is disposed so that an undercut is produced in the lower portion of this surface in a direction perpendicular to the contact surface 1011. In the embodiments of FIG. 7 and FIG. 8, the surface of the frame edge 1012 facing the shuttering shell 102 is inclined away from the shuttering shell 102 whereas, in the embodiment illustrated in FIG. 9, this surface is inclined towards the shuttering shell 102. In the embodiment illustrated in FIG. 9, the edge 1022 of the shuttering shell 102 is oriented perpendicular to the contact surface 1011. The sealing profile 1 is fixedly connected to the shuttering shell 102 by a mounting element 12 implemented as an adhesive surface. The sealing body 11, in portions, has a wedge-shaped design, the thickness between its two abutment surfaces 111a and 111b being larger on its side facing the contact surface 1011 than on its side facing the shaped surface 1021. As a result of this design, the sealing profile 1 is positively confined between the inclined edge of the shuttering frame 1012 and the shuttering shell 102 in the shown mounted state. In this way, the sealing profile 1 is effectively prevented from being pulled out between the frame edge 1012 and the shuttering shell 102 in a direction perpendicular to the contact surface 1011 in use. In this embodiment, the inclined arrangement of the surface of the frame edge 1012 facing the shuttering shell 102, in combination with the wedge shape of a portion of the sealing profile 1, does not result in a centration during the installation of the shuttering shell 102 in the shuttering frame. The embodiment illustrated in FIG. 9 ensures a particularly secure and firm fixation of the sealing profile 1 between the shuttering shell 102 and the shuttering frame 101. In this embodiment, however, a centred installation of the shuttering shell 102 in the shuttering frame 101 requires slightly more effort than in the embodiments of FIGS. 2, 6, 7, and 8.

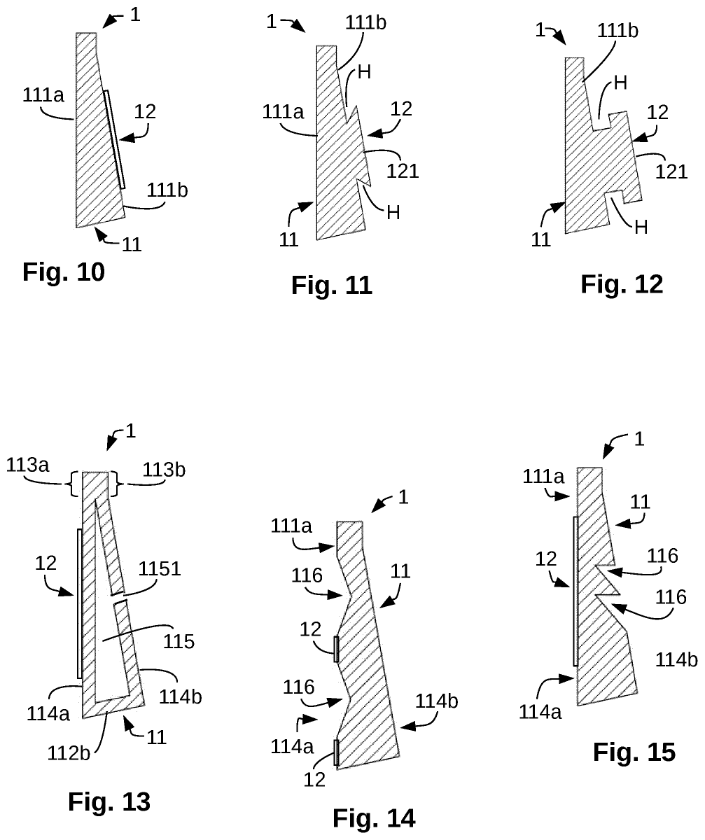

The embodiments of a sealing profile 1 shown in FIGS. 10 to 12 are provided for an attachment to the shuttering shell 102. The embodiments of a sealing profile 1 in FIGS. 10 to 12 all have a sealing body 11 which is identical to the sealing body 11 of the embodiment illustrated in FIG. 3. For details on this sealing body 11, therefore, the description relating to FIG. 3 is made reference to, respectively.

FIG. 10 shows a fourth embodiment of a sealing profile 1 in a cross-sectional view transverse to the direction of extension ER. This embodiment corresponds to the embodiment shown in FIG. 3 except that a mounting element 12 implemented as an adhesive surface is disposed on the second abutment surface 111b oriented towards the right. In use, the sealing profile 1 is attached to the edge 1022 of the shuttering shell 102 by this mounting element. The sealing profile 1 illustrated in FIG. 10 may be mounted, for example, in a shuttering element 100 according to one of the embodiments of FIG. 6, 7, or 9.

FIG. 11 shows a fifth embodiment of a sealing profile 1 in a cross-sectional view transverse to the direction of extension ER. This embodiment corresponds to the embodiment illustrated in FIG. 4 except that a mounting element 12 implemented as a protrusion 121 is disposed on the second abutment surface 111b oriented towards the right. For details relating to the shape of the protrusion 121 and the arrangement of the two undercuts H the description relating FIG. 4 is made reference to.

FIG. 12 shows a sixth embodiment of a sealing profile 1 in a cross-sectional view transverse to the direction of extension ER. This embodiment corresponds to the embodiment illustrated in FIG. 5 except that a mounting element 12 implemented as a protrusion 121 is disposed on the second abutment surface 111b oriented towards the right. For details on the shape of the protrusion 121 and the arrangement of the two undercuts H, the description relating to FIG. 5 is made reference to.

In FIGS. 13 to 15, embodiments of a sealing profile 1 are illustrated which have a sealing body 11 exhibiting a modified elastic behaviour as compared to the embodiments of FIGS. 3 to 5 and FIGS. 10 to 12.

FIG. 13 shows a seventh embodiment of a sealing profile 1 in a cross-sectional view transverse to the direction of extension ER. The outer shape of the sealing body 11 of the embodiment of a sealing profile 1 illustrated in FIG. 13 corresponds to the embodiment described in FIG. 3. In the embodiment illustrated in FIG. 13, a hollow space 115 which extends through the sealing profile 1 along the direction of extension ER, i.e., into the drawing plane, at a constant cross section is disposed in the interior of the sealing body 11. In the cross-sectional view, this hollow space 115 has a triangular shape. The hollow space 115 is disposed between the two guide portions 114a and 114b. The hollow space 115, on the other hand, is not disposed between the two sealing surfaces 113a and 113b. The wall thickness of the sealing body 11 around the hollow space 115 is substantially constant on the the guide portions 114a and 114b as well as on the second end surface 112b. In use, air is present in the hollow space 115. As compared to a massive sealing body 11 having the same outer shape, the illustrated sealing body 11 having a hollow space 115 has a lower spring rigidity in a direction perpendicular to the sealing surfaces 113a and 113b. In this way, the sealing body 11 offers less resistance to the shuttering shell 102 during the installation of the shuttering shell 102 in the shuttering frame 101 in the embodiment illustrated in FIG. 13 so that it can be mounted with less effort involved. In addition, the hollow space 115 results in savings in material as compared to a sealing body 11 having a massive design. The elastic properties of the sealing body 11 can be adjusted by varying the position and the size of the hollow space 115. A connection opening 1151 connecting the hollow space 115 to the outside of the sealing body 11 through the second guide portion 114b can be seen facing towards the right in the illustration. Through this connection opening, air can escape to the outside from the hollow space 115 in case of a compression or elastic deformation of the sealing body 11. However, such a connection opening 1151 is not essential. In the illustrated embodiment, the sealing profile 1 has an adhesive surface disposed on the first guide portion as the mounting element 12. Alternatively, other embodiments of a mounting element 12 may also be disposed on the sealing body 11, for example, a protrusion 121 according to one of the embodiments of FIG. 4 or 5. Furthermore, the mounting element 12 may also be disposed on the second guide portion 114b. Generally, a hollow space 115 may also be combined with other embodiments of a sealing profile 1.

FIG. 14 shows an eighth embodiment of a sealing profile 1 in a cross-sectional view transverse to the direction of extension ER. The outer shape of the sealing body 11 of the embodiment of a sealing profile 1 illustrated in FIG. 14 is based on the embodiment described in FIG. 3. In the embodiment illustrated in FIG. 14, two recesses 116 are disposed in the first abutment surface 111a, in the first guide portion 114a. These two recesses 116 interrupt the first abutment surface 111a. As a result of the recesses 116, the thickness of the sealing body 11 is, in portions, reduced. This results in changed elastic properties of the sealing body 11. Due to the recesses 116, the rigidity of the sealing body 111 is reduced as compared to an embodiment in which the sealing body has a massive design as shown, for example, in FIG. 3 In this way, the sealing body 11 offers less resistance to the shuttering shell 102 during the installation of the shuttering shell 102 in the shuttering frame 101 so that it can be mounted with less effort involved. In the illustrated embodiment, two adhesive surfaces forming the mounting element 12 are disposed on the portions of the first guide portion 114a disposed adjacent to the recesses 116. The recesses 116 are disposed in a portion of the first abutment surface 111a which is located outside of the first sealing surface 113a. In this way, the recesses 116 do not affect the sealing effect of the sealing surfaces 113a and 113b. The embodiment of a sealing body 11 shown in FIG. 14 may of course also be combined with a mounting element 12 formed by a protrusion 121. Here, the recesses 116 have a triangular cross section and extend over the entire sealing profile along the direction of extension ER. It is also possible to arrange recesses 116 only in portions of the sealing profile along the direction of extension ER.

FIG. 15 shows a nineth embodiment of a sealing profile 1 in a cross-sectional view transverse to the direction of extension ER. The outer shape of the sealing body 11 of the embodiment of a sealing profile 1 illustrated in FIG. 15 is also based on the embodiment described in FIG. 3. In the embodiment illustrated in FIG. 15 two recesses 116 are incorporated in the second guide portion 114b in the second abutment surface 111b oriented towards the right. These recesses 116 are implemented so that they are smaller than the recesses 116 in FIG. 14. To the first abutment surface 111a oriented towards the left, a mounting element 12 implemented as an adhesive strip is attached. In the embodiment illustrated in FIG. 15, the recesses 116 are therefore located on the side of the sealing body 11 facing away from the mounting element 12. The recesses 116 reduce the surface area of the second guide portion 114b along which the edge 1022 of the shuttering shell 102 slides during the installation of the shuttering shell 102 in the shuttering frame 101. As a result of this reduction of the surface area of the second guide portion 114b, the friction during the installation of the shuttering shell 102 is reduced. As a result of this reduced friction, the shuttering shell 102 can be mounted in the shuttering frame 101 with a reduced force. Like in the embodiment illustrated in FIG. 14, the recesses 116 are disposed outside of the area of the two sealing surfaces 113a and 113b and do therefore not affect their sealing effect in the mounted state of the shuttering element 100. Of course, it is also possible to provide more than the two recesses 116 shown, for example, three, or four recesses 116. The embodiment illustrated in FIG. 15 may also be combined with a mounting element 12 implemented as a protrusion 121.

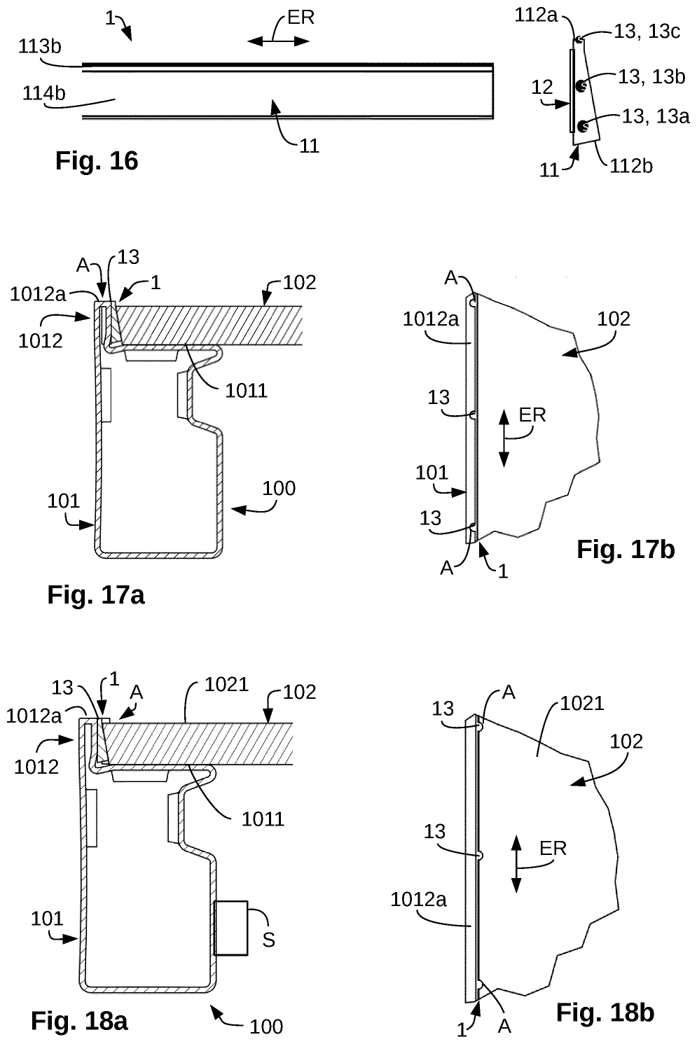

FIG. 16 shows an embodiment of a sealing profile 1 including sensors in a side view and a cross-sectional view transverse to the direction of extension ER. On the left side in FIG. 16, a portion of a sealing profile 1 is illustrated in a side view. The outer shape of the sealing body 11 of the embodiment illustrated in FIG. 16 corresponds to the embodiment which is illustrated in and described in connection with FIG. 3. In the side view, it can be seen that the second sealing surface 113b and the second guide portion 114b are disposed adjacent to each other. The embodiment of a sealing profile 1 illustrated in FIG. 16 includes a plurality of sensors 13 which are disposed in the interior of the sealing body 11 or on the edge of the sealing body 11 so that they are partly located on or in a surface of the sealing body 11. These sensors 13 are provided to detect measured values or data which accrue in connection with the erection of a building part in use of the shuttering element 100. For example, a sensor 13 can be implemented as a temperature sensor which detects the temperature in the immediate vicinity of the building part to be produced, particularly while the initially liquid concrete material hardens. In addition, a sensor 13 of another type may also be provided, for example, a humidity sensor, or a pressure sensor. It is also possible to arrange a plurality of sensors 13 of different types on or in the sealing body 11. The view on the right side in FIG. 16 is a cross-sectional view of the sealing profile 1 in a sectional plane perpendicular to the direction of extension ER. In the cross-sectional view, altogether three sensors 13 can be seen. A first sensor 13a is disposed within the sealing body 11 in the vicinity of the second end face 112b. A second sensor 13b is located inside the sealing body 11 about in the centre in the vertical direction in the illustration. A third sensor 13c, in portions, is located inside the sealing body 11 between the sealing surfaces 113a and 113b. A portion of this sensor 13c is disposed in and interrupts the first end face 112a. The sensor 13c may also slightly protrude beyond the first end face 112a. The sensor 13c may be implemented, for example, as a humidity sensor which directly contacts the concrete material in use due to its arrangement. In addition, this sensor 13c may also be implemented as a pressure sensor. The sensors 13a and 13b disposed in the interior of the sealing body 11 may be implemented, for example, as temperature sensors. The sensors 13 may be connected to a control device S preferably arranged on the or in the shuttering frame 101, either in a wireless or in a cable-based fashion. Here, a control device S is to be understood to be a device which receives, stores, and preferably also analyses or further processes the data detected by the sensors 13. The arrangement or accommodation of sensors 13 in the sealing profile 1 is advantageous in that they are disposed in the immediate vicinity of the concrete material of the building part to be erected. In addition, sensors 13 may be disposed in the interior or at least partly surrounded by the sealing body 11 in a protected manner. Furthermore, sensors 13 arranged in the sealing profile 1 may be retrofit in existing shuttering elements 100 in an easy manner by simply using a corresponding sealing profile 1 for the sealing between the shuttering shell 102 and the shuttering frame 101.

FIG. 17a shows a cross-sectional front view of a portion of another embodiment of a shuttering element 100 according to the invention comprising a sealing profile 1 including sensors 13. The embodiment illustrated in FIG. 17a is based on the embodiment illustrated in FIG. 2. However, in the embodiment illustrated in FIG. 17a, the sealing profile 1 includes a plurality of sensors 13. The sectional plane in FIG. 17a corresponds to the sectional plane II indicated in FIG. 1. The sealing profile 1 is cut so that the sectional plane is not located in a portion in which a sensor 13 is disposed. However, it can be seen in FIG. 17a that, behind the sectional plane, a sensor 13 is disposed which is arranged adjacent to or adjoining the first end face 112a. The thickness of the sealing body 11 between its abutment surfaces 111a and 111b in a direction parallel to the contact surface 1011 is larger in the position in which a sensor 13 is disposed in the direction of extension ER than its thickness in a position in which no sensor 13 is disposed. Such a position in which a sensor 13 is disposed is located behind the sectional plane. There, the thickness of the sealing body 1 is larger than in the sectional plane. In this position, the sealing body 11 extends further into the frame edge 1012 than in the sectional plane. For accommodating this thicker area of the sealing body 11, a recess A extending into the end face 1012a is provided in the frame edge 1012 in the illustrated embodiment. In the plan view in FIG. 17b, the recess A can be clearly seen. The embodiments illustrated in FIGS. 17a, 17b, 18a, and 18b render the arrangement of sensors 13 having larger dimensions than the distance between the shuttering shell 102 and the shuttering frame 101 in a shuttering element 100 in its sealing profile 1 possible. Particularly pressure sensors frequently have a measuring surface which is larger than the typical distance between the shuttering shell 102 and the shuttering frame 101. The recesses A in the shuttering frame 101 renders the arrangement of such sensors 13 in thicker portions of the sealing body 11 possible. In addition, these recesses A in combination with the thicker portions of the sealing body 11 may, at the same time, be used for fixing the sealing profile 1 on the shuttering frame 101. For example, a thicker portion of the sealing body 11 in which a sensor 13 is disposed may, at the same time, serve as a mounting element 12. Of course, it is also possible to provide a mounting element 12 having another design, for example, an adhesive surface or a protrusion 121 in addition to these thicker portions.

FIG. 17b shows a plan view of a portion of the embodiment of a shuttering element 100 illustrated in FIG. 17a. In FIG. 17b, a plan view from above of the embodiment illustrated in FIG. 17a can be seen. In this plan view, it can be seen that a plurality of recesses A is disposed in the frame edge 1012 at a distance to each other in the direction of extension ER. These recesses extend from the surface of the frame edge 1012 facing the shuttering shell 102 into the end face 1012a. In the illustrated embodiment, the recesses A have the shape of a semi-circle in the illustrated plan view. However, the recesses A may of course also have another shape. According to the shape of the recesses A, the sealing profile 1, particularly its sealing body 11, is implemented so that it is thicker and complementary in shape to the recesses A in spaced-apart positions along the direction of extension ER. In these positions, sensors 13 may be disposed, respectively. However, it is not essential that a sensor 13 is actually installed in each of these thicker portions or in each recess A in the shuttering frame 101. In FIG. 17b, only a portion of the shuttering element 100 is illustrated in the plan view. In the illustrated embodiment, a sealing profile 1, in combination with recesses in the frame edge 1012, may be disposed around the entire shuttering element 100. Alternatively, it is possible to arrange the shown embodiment only in a portion of the circumference, for example only on a side of the shuttering element 100.

FIG. 18a shows a cross-sectional front view of a portion of another embodiment of a shuttering element according to the invention comprising a sealing profile 1 including sensors 13. The embodiment illustrated in FIG. 18a is similar to the embodiment illustrated in FIG. 17a. Unless described otherwise, therefore, the description relating to FIG. 17a is made reference to. The sealing body 11 of the embodiment illustrated in FIG. 18a includes at least one sensor 13, the thickness of the sealing body 11 being larger in the position in which the sensor 13 is disposed than in positions in the direction of extension ER in which no sensor 13 is disposed. In contrast to the embodiment illustrated in FIG. 17a, however, the larger thickness of the sealing body 11 in the area of the sensor 13 does not extend into the frame edge 1012 but into the shaped surface 1021 of the shuttering shell 102. For accommodating this thicker portion, the shuttering shell 102 has a recess A in the illustrated embodiment. This recess A extends into the shaped surface 1021 and is implemented so that it is complementary in shape to the portion of the sealing body 11 on which the sensor 1 is disposed. The interaction of the recess A and the sealing profile 1 can be seen in the plan view in FIG. 18b. On the side of the shown portion of the shuttering frame 101 oriented towards the right in the illustration a control device S is disposed. This control device S wirelessly communicates with one or a plurality of sensors 13 disposed in the sealing body 11. In the illustrated embodiment, the control device S is disposed below the shuttering shell 102 in a protected manner and is located in the vicinity of the sensor 13. In this way, on the one hand, a good signal transmission between the wirelessly operating sensor 13 and the control device S is ensured. On the other hand, the control device S is protected against environmental impacts and damage in use by its arrangement inside the shuttering frame 101 and below the shuttering shell 192. The control device S itself may in turn wirelessly communicate with other control devices S or a server and transmit the measured values detected by the sensor 13 for analysis.

FIG. 18b shows a plan view of a portion of the embodiment of a shuttering element 100 illustrated in FIG. 18a. In FIG. 18b, it can be seen that the shuttering shell 102 has a plurality of recesses A which extend into the shaped surface 1021. In this way, the edge portion of the shuttering shell 102 can be used for the arrangement of sensors 13 which are integrated in the sealing profile 1. In the illustrated embodiment, the positive connection of the sealing profile 1 to the recesses A in the area of the sensors 13 may, at the same time, also be used for the attachment of the sealing profile 1 to the shuttering shell 102. It is also possible to combine the embodiment shown in FIG. 18b with the embodiment shown in FIG. 17b and to arrange recesses A or at least parts of recesses A which will then accommodate portions of the sealing body 11 in which sensors 13 are disposed in the mounted state of the shuttering element 100 both in the shuttering shell 102 and in the frame edge 1012.

### LIST OF REFERENCE NUMERALS

1 Sealing profile
11 Sealing body
111a, 111b Abutment surface
112a, 112b End face
113a, 113b Sealing surface
114a, 114b Guide portion
115 Hollow space
116 Recess
12 Mounting element
121 Protrusion
100 Shuttering element
101 Shuttering frame
1011 Contact surface
1012 Frame edge
1012a End face
102 Shuttering shell
1021 Shaped surface
1022 Edge
1023 Force transmission surface
α Angle
α′ Angle
A Recess
B Mounting member
ER Direction of extension
H Undercut
S Control device

1. A shuttering element for shuttering of a building part comprising:
a shuttering frame which supports the other elements of the shuttering element and, in use, absorbs loads acting on the shuttering element,
at least one shuttering shell which is connected to the shuttering frame and which, in use, rests with a shaped surface against a building part to be erected, wherein an edge extends around the shaped surface,
at least one sealing profile which is located between the shuttering shell and the shuttering frame wherein the sealing profile which extends along a direction of extension comprises the following elements:
at least one sealing body which, at least in portions, is made of an elastic material, wherein the sealing body has at least two abutment surfaces which, at least in portions, abut on the shuttering frame and/or the shuttering shell, wherein the abutment surfaces are disposed on opposite sides of the sealing body and respectively extend parallel to the direction of extension, and wherein each of the abutment surfaces is larger than the end faces of the sealing body disposed between the abutment surfaces, wherein the sealing body has at least two sealing surfaces respectively one of which forms a portion of an abutment surface,
at least one mounting element which is connected to the shuttering frame or the shuttering shell, wherein the mounting element is connected to the sealing body,
wherein the shuttering frame has a contact surface on which, in use, the shuttering shell rests in portions, and the shuttering frame also has a frame edge which is located next to the contact surface and extends around said contact surface at least in regions, wherein the frame edge protrudes beyond the contact surface in a direction perpendicular to the contact surface, and wherein the sealing profile is located, at least in regions, between the frame edge and the edge of the shuttering shell extending around the shaped surface, and a surface of the frame edge oriented in the direction of the shuttering shell is arranged at an angle other than 90° with respect to the contact surface and/or the edge is arranged at an angle other than 90° with respect to the contact surface.

2. The shuttering element according to claim 1, wherein the thickness of the sealing profile varies in size starting from a plane defined by the shaped surface in the direction of a plane defined by the contact surface.

3. The shuttering element according to claim 1, wherein the sealing body, at least in portions, has a wedge-shaped design in a cross-sectional view perpendicular to the direction of extension, wherein at least one guide portion of the first abutment surface is arranged at an angle with respect to at least one guide portion of the second abutment surface, wherein the guide portion forms a portion of the first abutment surface, and the guide portion forms a portion of the second abutment surface.

4. The shuttering element according to claim 1, wherein the mounting element is formed by an adhesive surface which is disposed on a portion of one of the abutment surfaces or on the second end face.

5. The shuttering element according to claim 1, wherein the mounting element is formed by a protrusion which protrudes beyond one of the abutment surfaces or the second end face.

6. The shuttering element according to claim 1, wherein the sealing body has at least one hollow space in its interior and/or the sealing body has at least one recess which is disposed in one of the abutment surfaces or one of the end faces and interrupts one of these surfaces.

7. The shuttering element according to claim 1, wherein the sealing profile includes at least one sensor which is implemented as a temperature sensor, a humidity sensor, a pressure sensor, a force sensor, or an expansion sensor.

8. The shuttering element according to claim 7, wherein the sensor, at least in portions, is enclosed by the sealing body, and/or the sensor, at least in portions, is disposed in one of the end faces or one of the sealing surfaces and interrupts one of these surfaces.

9. The shuttering element according to claim 1, wherein the first abutment surface abuts on the frame edge, and the second abutment surface abuts on the edge of the shuttering shell, and/or the first end face is disposed between the shaped surface and the frame edge in a plan view of the shaped surface, and/or the second end face abuts on the contact surface or a surface of the shuttering frame disposed adjacent to it.

10. The shuttering element according to claim 1, wherein the sealing body, at least in portions, is elastically deformed between the shuttering frame and the shuttering shell in use.

11. The shuttering element according to claim 1, wherein the mounting element is disposed on the first abutment surface and connected to the frame edge, or the mounting element is disposed on the second abutment surface and connected to the edge of the shuttering shell.

12. The shuttering element according to claim 1, wherein the surface of the frame edge oriented in the direction of the shuttering shell is arranged perpendicular to the contact surface, and a first guide portion of the sealing profile is arranged at an angle with respect to a second guide portion of the sealing profile so that the sealing body, at least in portions, has a wedge-shaped design, and wherein the edge of the shuttering shell, at least in portions, is arranged at the angle+90°) with respect to the force transmission surface.

13. The shuttering element according to claim 1, wherein the surface of the frame edge oriented in the direction of the shuttering shell is arranged at an angle of +90°) with respect to the contact surface, and a first guide portion of the sealing profile is arranged at an angle with respect to a second guide portion of the sealing profile so that the sealing body, at least in portions, has a wedge-shaped design, and wherein the edge of the shuttering shell, at least in portions, is arranged perpendicular to the force transmission surface.

14. The shuttering element according to claim 1, wherein the sealing profile comprises at least one sensor, wherein the thickness of the sealing body is larger in a position in which, in the direction of extension, a sensor is disposed, than the thickness of the sealing body in a position in which, in the direction of extension no sensor is disposed, and the shuttering shell or the frame edge has a recess in the position in which the thickness of the sealing profile is larger due to the arrangement of a sensor, wherein this recess, starting from the edge, extends into the shaped surface of the shuttering shell or, starting from a surface of the frame edge facing the shuttering shell extends into a surface of the frame edge arranged parallel to the contact surface.

15. A method for assembling a shuttering element according to claim 1, the method comprising:
providing a shuttering frame which has a contact surface which, in use, the shuttering shell, in portions, abuts on, and the shuttering frame also has a frame edge which is disposed adjacent to and, at least in portions, extends around the contact surface, wherein the frame edge protrudes beyond the contact surface in a direction perpendicular to the contact surface,
providing a shuttering shell which, with a shaped surface, abuts on a building part to be erected in use, and which has a force transmission surface disposed opposite of the shaped surface, wherein an edge extends around the shuttering shell and connects the shaped surface to the force transmission surface,
attaching a sealing profile to the frame edge of the shuttering frame or to the edge of the shuttering shell,
introducing the shuttering shell into the frame edge of the shuttering frame, wherein the sealing profile positions, particularly centres, the shuttering shell with respect to the shuttering frame until the force transmission surface of the shuttering shell, in portions, abuts on the contact surface of the shuttering frame,
attaching the shuttering shell to the shuttering frame.

16. The shuttering element according to claim 1, wherein the at least one sealing profile connects the edge of the shuttering shell extending around the shaped surface to the shuttering frame in a sealing manner.

17. The shuttering element according to claim 1, wherein the mounting element is disposed on one of the abutment surfaces.

18. The shuttering element according to claim 2, wherein the thickness of the sealing profile is a distance between the abutment surfaces in a direction perpendicular to the direction of extension and parallel to the contact surface.

19. The shuttering element according to claim 14, wherein the thickness of the sealing profile is between the abutment surfaces.
